(19) United States
(12) Patent Application Publication
(10) Pub. No.: US 2008/0189173 A1
(43) Pub. Date: Aug. 7, 2008

(54) Vision Center Kiosk

(75) Inventors: Sherwyne R. Bakar, Palo Alto, CA (US); Jorlin E. Moon, Los Altos, CA (US)

Correspondence Address: MORRISON & FOERSTER LLP, 755 PAGE MILL RD, PALO ALTO, CA, 94304-1018, US

(73) Assignee: Panaseca, Inc.

(21) Appl. No.: 11/661,791

(22) PCT Filed: Sep. 2, 2005
(86) PCT No.: PCT/US05/31460

§ 371 Date: Feb. 12, 2008

Related U.S. Application Data
(60) Provisional application No. 60/607,170, filed on Sep. 3, 2004.

(51) Int. Cl. G06Q 30/00

(52) U.S. Cl. 705/14; 705/1; 351/222

(57) ABSTRACT

A system comprising a kiosk is provided where the kiosk is for assessment of a user's needs including, for example, vision needs. A method of assessing a user's needs and a method of advertising products and services such as vision related products and services are further provided.

### CROSS-REFERENCE TO RELATED APPLICATIONS

This application claims the benefit of U.S. Provisional Application No. 60/607,170, filed Sep. 3, 2004, which application is incorporated herein in its entirety.

### FIELD OF THE INVENTION

This application relates to a system and method for determining various vision and ocular parameters and presence of eye conditions such as ocular allergies, dry eyes or irritated eyes as well as for recommending a method for treatment of such eye conditions. This application is related to U.S. Pat. No. 6,592,223, the contents of which are incorporated by reference in their entireties.

### BACKGROUND OF THE INVENTION

There are an increasing number of computer users in the world ranging from the age 6 to 60 and over. With the introduction of the internet and the transition of many jobs for the which the computer is becoming a central part, users are spending more time on the computer at work and at home. It is estimated that up to 70% of workers who spend over 3 hours a day on a computer suffer from one or more of the symptoms of “Computer Vision Syndrome” or CVS. The symptoms are due to a variety of musculoskeletal and vision related stresses that accompany computer use. The vision related symptoms include, among others, eye strain, red and irritated eyes, foreign body sensation in the eye, blurred vision of near objects, blurred vision of distant objects, and a condition known at “Dry Eye.”

Dry Eye is a condition that can be the leading cause or a contributor to many of the visual symptoms experienced by the computer user. Eye dryness can result from a number of factors including certain health conditions, side effects of medications and age, computer viewing and environmental conditions such as humidity and air circulation surrounding a computer user. Further, it is observed that a person's blink rate diminishes when engaged in computer work. This leads to increased exposure of the corneal surface to air that can cause evaporation of the protective tear film resulting in drying of the eyes and the accompanying symptoms of redness, irritation, and pain.

There is thus an unmet need to provide an easy and convenient means for people, for example, the computer users, to assess their vision and eye conditions on a frequent basis to enable them to become aware of changes in their eyes and vision and/or to direct them to professional eye care products and services as needed.

Similarly, it will be desirable if there are easy and convenient ways to assess a person's other personal, medical and health care needs, such as hearing, for example, and provide immediate feedback, including educational and advertising information regarding such.

### SUMMARY OF THE INVENTION

It is one of the objects of the present invention to provide a system and method to address the unmet needs in the art in the area of an individual's personal, medical and health care needs.

It is also one of the objects of the invention to provide a kiosk that can provide vision and ocular health self screening (“a Vision Center Kiosk” for easy reference) that includes assessing one or more of the following: a person's distant vision, near vision, computer vision, central vision, field of clear view, contrast acuity, amplitude of accommodation, accommodative facility, tear film, blink rate, eye dryness and/or ocular allergies. While these assessments are beneficial to all people and can discover serious eye conditions, they are especially helpful for increasing the comfort, health, and productivity of computer users. The Vision Center will also suggest to the user vision care products and services based on their individual assessment and dispense coupons for these and other products.

Another one of the objects of the present invention is to provide a system of mirrors and lenses within a kiosk that define an optical path for projection of an image to be viewed by the user. Such as an image may be stationary, requiring the user to adjust his or her position for viewing, or adjustable through automatic or manual means in accordance to the height of user standing in front of the kiosk.

It is a further one of the objects of the present invention to provide a smart sound system that contains an automatically adjustable sound level, such as, for example, becoming louder when a person approaches and softer when a person departs, or vice versa.

In accordance to one of the objects, therefore, there is provided the invention as more clearly defined in the following exemplary embodiments, which should not be considered as limiting, as the invention is only limited by the appended claims:

In one embodiment, the present invention provides a system for use by a user comprising a kiosk that comprises: (a) an optical system for transmitting input or output information; (b) one or more display screens for displaying input and/or output information; (c) a means for accepting an input; optionally (d) one or more sensors; optionally, (e) access to a microprocessor for processing input and output information; and optionally (f) access to a memory for storage of input and/or output information; wherein the system is configured to accept input from a user or optionally from the one or more sensors, and to provide output to at least one of the optical chamber and the one or more display screens.

In another embodiment, there is provided a system as above, wherein the system comprises the access to a microprocessor. In one aspect of the invention, the microprocessor comprises access through Internet.

In yet another embodiment of the invention, there is provided a system as above, wherein the system comprises the access to a memory.

In a further embodiment, there is provided a system as above, further comprising a means for adjusting an optimal viewing angle between the user and the display. In one aspect of the invention, the means for adjusting the optimal viewing angle comprises a servo mechanism. In another aspect of the invention, the means for adjusting the optimal viewing angle comprises a manual means. For example, the manual means comprises a knob or an adjustable display screen.

In as yet another embodiment, there is provided a system as above, wherein at least one of the one or more sensors is used to determine a user's location relative to the one or more display screens. In one aspect of the invention, at least one of the one or more sensors comprises a distance sensor or an image sensor. In another aspect of the invention, at least one of the one or more sensors is used to determining a user's height or location of a user's eyes.

The present invention further provides a system as above, further comprising a vision assessment means for assessing a user's vision, visual condition or ocular health. In one aspect of the invention, the vision assessment means comprises a first algorithm.

In another embodiment of the invention, the system herein further comprises an adjusting means for automatically adjusting vision assessment to a user's height. In one aspect of the invention, the adjusting means comprises a servo mechanism.

In still another embodiment of the invention, the system as above further comprises a means for automatically adjusting size of displayed characters to a specified accuracy based on a user's location or position. In one aspect of the invention, the specified accuracy is 20/20, 20/30, 20/40 or 20/50, or any vision acuity in between.

In a further embodiment of the system as above, the means for automatically adjusting size of displayed characters comprises a second algorithm.

The system of claim 1, wherein the kiosk further comprises a means for providing a variable intermediate or distance vision assessment. In one embodiment, the means for providing a variable intermediate or distance vision assessment comprises a combination of mechanical and software means. In one aspect of the invention, the mechanical means comprises mechanically moving the display screen.

The system of the invention optionally comprises a means for retrieving or analyzing information, and/or a printer.

In one embodiment, the present system accepts input including physical or voice input. Optionally, the input may be from a user.

In one embodiment, the present system is configured to provide information about vision problems or eye health issues, one or more suggestions regarding one or more products or services, such as vision related products or vision related services, and/or one or more coupons for one or more vision related products or services.

In another embodiment, the present system is configured to conduct an assessment of a user's vision or ocular health comprising one or more of the following assessments: assessment of distant vision, assessment of near vision, assessment of intermediate vision, assessment of computer vision, assessment of central vision, assessment of field of clear view, assessment of accommodation, assessment of accommodative facility, assessment of contrast acuity, assessment of ocular allergies, assessment of dryness of eyes (mild, moderate, sever), assessment of blink rate (in number of blinks per minute), assessment of tear film breakup or assessments of one or more combinations thereof.

In one embodiment, the present system is configured to provide a recommendation based upon the assessment. In one aspect of the invention, the recommendation relates to potential remedies or referral to an eye specialist or to a product or to a service.

In another embodiment, the present system may be designed to allow a user to stand or sit in front of the screen or to be a stand-alone unit or a wall-mounted system or a desk top unit, or to be incorporated into a retail shelving system.

In yet another embodiment of the present invention, the system comprises at least two display screens. In one aspect of the invention, at least one of the one or more display screen is a touch screen or LCD. Optionally, at least one of the one or more display screens is configured to display one or more of: a menu, a means for navigation, result of an assessment, recommendation of a product or a service, and operating instructions. Further optionally, the system or display screen is configured to display vision assessment information at near vision, distance vision, and intermediate vision scale. Still optionally, the system is configured to display assessment information through a mirror assembly. In one aspect of the invention, the mirror assembly is so placed such that a path of sight varies from several inches to one or more meters. In another aspect of the invention, the mirror assembly is automatically adjustable to adjust to user position. In yet another aspect of the invention, the mirror assembly is manually adjustable.

In a further embodiment of the present invention, the system comprises more than one display screens and at least one of the one or more display screen is movable. In one aspect of the invention, the display screen is movable to create a desired path length related to a specific visual acuity relative to position of a user. In another aspect of the invention, the display screen is movable to create a target letter size relative to position of a user. In a further aspect of the invention, the system is configured to adjust automatically a letter size for display.

The present invention further provides a system as above comprising an algorithm, wherein the algorithm is configured to display a plurality of “C's” of size corresponding to a particular vision measurement and assessment. In one aspect of the invention, the plurality of “C's” is displayed after the distance between the display and the user is determined when the user positioned in front of the display.

In one embodiment of the invention, the system as above comprises a means to detect a user's distance from the one or more displays, such as a sensor. In one aspect of the invention, the sensor comprises a distance sensor, for example, an infrared, optical (camera) or an acoustic sensor, or a camera, or an infrared source or a humidity sensor.

In another embodiment of the invention, there is provided a system as above, further comprising one or more means to identify the eye region of a user, determine blink rate (blinks per minute), determine completeness of blink, determine vertical size of eye aperture (opening of the eye), or pupil size.

In a further embodiment, there is provided a system as above, wherein the system is configured to record response time for a user to respond to a query, or to record a level of blur, or to track eye movements or location.

In another embodiment, the system as above further comprises at least one speaker for projecting sound. In one aspect of the invention, the sound level of the kiosk can be automatically turned on or off or adjusted when an approaching person is sensed. Optionally, the sound is minimal until a person is sensed and is increased in volume as the person comes in close proximity to the kiosk.

In one embodiment of the invention, the system as above is operationally Internet enabled to download and upload information. In one aspect of the invention, the information uploaded or downloaded comprises the import of new software, advertising, coupons, and educational material, retrieval of user information, kiosk use statistics, maintenance, and operating status.

In one embodiment, the system as above is configured to send email, to accept information regarding the user, to issue one or more coupons, for example, a coupon for a recommended product, to dispense a sample, to assess a user's over-the-counter medical or health care needs, or to assess a user's hearing, or to assess a user's personal care needs, or to provide name and/or location of a service provider or a retailer or manufacturer.

In yet another embodiment, the system as above further comprises an ear or head phone or ear phone.

In a further embodiment of the present invention, there is provided a method of advertising to a user comprising the steps of: providing the system of any one of the foregoing; allowing a user to input information into the system; and allowing a user to obtain output from the system. In one aspect of the invention, the input and/or output information is vision-related.

The present invention further provides a method of assessing a user's personal, medical or health care needs comprising: providing the system of any one of the foregoing; allowing the system to display information or one or more questions relating to the user's personal, medical or health care needs; allowing the user to input user's response to one or more questions or user's input into the system; and allowing the user to receive an analysis of user's response from the system. In one aspect of the invention, the method further comprises the step of allowing the user to receive a suggestion or recommendation for a product or service from the system.

Other objects, features or advantages of the present invention will be clear to a person of ordinary skill in the art upon review of the description herein. Such other objects, features and advantages are considered part of the present invention.

### DESCRIPTION OF THE DRAWINGS

FIG. 1 is a diagrammatic representation of the front view layout of one exemplary embodiment of a kiosk of the present invention. In this embodiment, the kiosk (1) contains at least three compartments: the top compartment (2) contains electronics and/or an upper video display, the middle compartment (3) contains an optical chamber; and the lower compartment (4) contains a lower display and navigation means, where the three compartments are supported by a stand (5).

FIG. 2 is a diagrammatic representation of the side view of the same kiosk (1) as shown in FIG. 1 where an Upper Monitor (6) is situated in the top compartment (2), and a Lower Monitor that may be a touchscreen monitor (7) and Touchpad (or joystick) (8) are situated in the lower compartment. The Optical Chamber (9) resides between the Upper Monitor (6) and the Lower Monitor (7) and houses an LCD (10).

FIG. 3 is a diagrammatic representation of the front view of another embodiment of the present kiosk showing the possible placement of a humidity sensor (11), cameras (12), speakers (13), an Upper Monitor (6), a Lower Monitor (7) with a touchpad or a joystick (8), Display 1 (14) such as for viewing near vision, for example, and Display 2 (15) such as for viewing distance vision, for example, both of which are connected to an optical chamber (not shown) for conducting intermediate and distance vision assessments, respectively. Intermediate distance assessment, such as one's computer viewing distance, can also be assessed on the lower monitor.

FIG. 4 is a diagrammatic representation of a three-dimensional view of one embodiment of the present kiosk, showing a first Display Screen (or Upper Monitor) (6), a second Display Screen (or Lower Monitor) (7), an Optical Chamber (9) that begins with a view port (20), Display 1 (14) such as for near vision assessment and Display 2 (15) such as for distance vision assessment. Also shown are placements of a humidity sensor (11) and distance sensor (16) at the top of the kiosk (1), a computer, microprocessor or memory device (17), a printer (18) and a servo mechanism (19) (not shown). A distance sensor (16) can be an infrared (IR) sensor which can be mounted above an adjustable mirror connected to a servo mechanism (19) (not shown).

FIG. 5 is a diagrammatic representation of one embodiment of the present kiosk that houses a smart sound technology system. FIG. 5A shows one possible placement of the distance sensor (16) above the Upper Monitor (6) and a View Port (20) that is situated between the Upper Monitor (6) and a Lower Monitor (7). FIG. 5B is a diagrammatic representation of the emitted distance sensor pattern showing the range of detection of the distance sensor (16) as it is configured to activate or inactivate a sound system such that when a user is situated within the limits of the distance sensor pattern represented by the triangle (21), for example, the sound system becomes either activated or deactivated, as desired. FIG. 5C shows a variation of FIG. 5B, showing the placement of the distance sensor between the Upper Monitor (6) and the Lower Monitor (7).

FIG. 6 is an illustration of the operation of the Smart Sound Technology as a graph, showing the relationship between the volume level of sound and the distance a user is from the display screen or from the system herein. Thus, in one embodiment of the present kiosk, a distance sensor with a broad pattern as shown in FIG. 5B can be used to detect the approach of a person. Upon detection, the system begins to play an audio recording, such as one stored in memory. The sound level can be made constant or may change as the person comes nearer the system, such as louder or softer.

FIG. 7A is a diagrammatic representation of two different positions of a display (7 or 22) where the display screen is adjusted from a vertical position “a” to position “b” to obtain an optimal viewing angle for the user. FIG. 7B is a diagrammatic representation of another embodiment of the present system containing a single monitor or display (22) situated under an optical chamber (3).

FIG. 8A is a diagrammatic representation of a side view of one embodiment of the present vision center kiosk showing one possible optical path (23) as defined by a system of lenses and mirrors housed inside the kiosk, as well as the placement of a computer (17), the printer location (18) and a base (5). FIG. 8B is a diagrammatic representation of the front view of the same kiosk as in FIG. 8A. The computer (17) is depicted in the base (5) of the kiosk. However, the computer (17) may be located in other part of the kiosk, such as in the upper portion of the kiosk, as desired.

FIG. 9 is a diagrammatic representation of an array of mirrors and possible light paths in one embodiment. FIG. 9A shows the Far Vision Ray Path (35), i.e., the path of light from LCD (29) that reflects off mirrors (30) and (31) and enters the periscope (24) for far vision assessment. FIG. 9B shows the Near Vision Ray Path (36), i.e., the path of light from LCD (29) that reflects off mirror (32) to the viewing port (20) for the near vision assessment. FIG. 9C shows the Far Vision Ray Path (37), i.e., the path of light from the periscope (24) that reflects off mirrors (34), (33) and (32) to the viewing port (20) for the far vision assessment. FIG. 9D shows the path of light incoming from the LCD (29) that reflects off mirrors (28), (35), (27), (26) and then from mirror (26) to mirrors (35) and (28) out to a servo-controlled mirror (not shown) to optimize viewing angle depending on height of a user. FIG. 9A-D depict one of many optical chamber designs that can provide an optical path to achieve a desired viewing distance between the originating vision patterns and the user. FIG. 9E shows a variation of the mirror assembly, with individual mirrors (61) defining an optical path (62), projecting an image from LCD (20) to the exit image (63) which may be viewed by a user.

FIG. 10A is a diagrammatic representation of a cross-section of one embodiment of the present kiosk (1), showing placement of the periscope (24) behind the upper monitor (6), view port (20) and the lower monitor (7). FIG. 10B is a three-dimensional representation of a chamber (38) that houses the periscope (24) and mirror assembly in one embodiment of the system herein.

FIG. 11A is a diagrammatic representation of one embodiment of the present kiosk, showing an upper monitor (6), a lower monitor (7) and a knob for manual adjustment of viewing angle of a display for vision assessment. FIG. 11B is a cross-sectional view of the kiosk of FIG. 11A, additionally showing a diagrammatic representation of an adjustable mirror and servo mechanism (40), the optical chamber (9), a printer (18) with paper roll and placement of a computer (17).

FIG. 12A is a diagrammatic representation of one embodiment of a desk version of the present kiosk, showing placement of the view port (20), a movable monitor screen (42), and a desk top (41). FIG. 12B is a diagrammatic representation of a side view of the desk version of the kiosk of FIG. 12A, additionally showing an optical chamber (9) and placement of a computer (17). In one embodiment, located within the view port (20) is an adjustable mirror (a “viewing mirror”) that is actuated by a servo. A distance sensor, such as an infrared distance sensor, is positioned above the mirror and reflects into the mirror and toward the user. With knowledge of the distance to the user and the angle of the mirror when the distance sensor senses a signal, such as the presence of a person, the servo can adjust the mirror so that the user can view a displayed target, for example, alpha-numeric characters, on a monitor display located at the end of the optical path of any length. Alternatively, in another embodiment, the desk version of the present kiosk will include a single monitor screen (42) that displays images on different portions of the display screen. An image displayed on one portion of the screen (42) will be reflected through an optical path of varying length and displayed on the viewing mirror for distance vision assessment. An image on another part of the screen (42) will be reflected through an optical path of a different length and displayed on the viewing mirror for near vision assessment. In another embodiment, the movable monitor screen (42) can be moved by a user to a normal viewing distance and an image can be displayed on the monitor screen (42) for user's computer vision assessment. Alternatively, the monitor may be fixed wherein the user can move closer or away from the monitor to approximate their normal computer viewing distance. The resolution of the displayed image on the monitor (42) can be enhanced by a de-magnifier lens assembly placed above the displayed image. The de-magnifier lens assembly may include a single lens, multiple lenses, or single or multiple lenses with mirrors that will effectively reduce the size of a displayed image to provide an apparent improvement in resolution.

FIG. 13A is a diagrammatic representation of a top view of a display (29), such as an LCD display, for originating various vision patterns, such as distance or near vision patterns, on different areas of the display (29), a mirror (43) situated adjacent to the LCD display (29) and a viewing port (20). FIG. 13B is a side view of the mirror (43) and the LCD display (29) as shown in FIG. 13A, illustrating the downward projection of the displayed distance vision patterns onto mirror (47) that reflects the distance vision pattern image into the optical chamber (9) (not shown), and showing the mirror (43) being positioned at an angle, preferably at about 45 degrees to the horizontal, upon which is displayed the distance vision patterns reflecting through the optical chamber (9) (not shown). The LCD display (29) may be positioned as shown in FIG. 13B or, to conserve space, rotated 90 degrees as shown in FIG. 13C. FIG. 13C is a side view illustrating the downward projection of the displayed near vision patterns onto mirror (48) and reflected to the user. The angle or height of mirror (48) may be adjustable to allow users to varying heights and distances from the mirror to view the reflected vision patterns. In FIG. 13C, the near vision patterns are displayed closest to the viewer and projected downward onto mirror (48) and outward to the viewer. The distance vision patterns are displayed on the portion of the LCD farther away from the viewer and projected downward onto mirror (47) and reflected from mirror (47) into the distance vision optical path. An expanded view of the mirror and display for distance vision is shown in FIG. 13D. An expanded view of the mirror and display for near vision is shown in FIG. 13E.

FIG. 14A is a diagrammatic representation of the front view of near vision patterns (50) reflected from a display (29) above onto mirror (48). The angle or height of mirror (48) may be adjustable to allow users of varying heights and distances from the mirror to view the reflected vision patterns (50). This is the view a user would see looking through the viewing port (20) which may be covered with a piece of glass (49), such as a slanted glass. A distance sensor (16) is shown above the viewing port (20). FIG. 14B is a diagrammatic representation of a side view of the reflected image path (51) of the near vision patterns (50) on mirror (48) and a servo mechanism (52) and connecting link (53) that allows mirror (48) to be adjusted to varying angles. Mirror (48) may be attached with a hinge (54) at the bottom (as shown) or hinged at the top (not shown), or not hinged at all but is moved by a servo (52) in a vertical direction to accommodate users of varying heights and distances from the mirror (48). A glass or plastic or other clear material (49) is shown to separate users from mirror (48) and is positioned at a slant to reduce glare to the user.

FIG. 15A is a diagrammatic representation of a front view showing the reflection of distance vision patterns onto mirror (48) as seen by a user. FIG. 15B is a diagrammatic representation of a side view showing mirror (43) reflecting distance vision patterns received through the optical path (56) and onto mirror (48) and from mirror (48) to user (57).

FIG. 16 is a diagrammatic representation of a distance sensor beam, such as from an infrared distance sensor (16), being directed onto adjustable mirror (48) and reflecting from the mirror (48) to the viewer (57). Changing the angle of mirror (48) changes the direction of the distance sensor beam. For example, if the servo (52) and connecting link (53) move the mirror (48) in a more horizontal position, the direction of the distance sensor beam will be directed in a more upward path. If the servo (52) and connecting link (53) move the mirror (48) in a more vertical position, the direction of the distance sensor beam will be directed in a more horizontal path. The distance sensor may be positioned at an angle (as shown) or vertically relative to the adjustable mirror, (not shown).

FIGS. 17A and 17B are diagrammatic representations of how the distance sensor (16) and adjustable mirror (48) determine the height of a viewer or user (57). Mirror (48) is first angled in a nearly horizontal position so that the path of the distance sensor beam (58) is directed above the heads of most viewers. Using small increments, the servo (52) begins to increase the angle of mirror (48) relative to the horizontal which produces a sweeping motion of the distance sensor beam (58) in a downward direction. When the path of the distance sensor beam intersects the top of the head of a user (57), the distance sensor records a distance measurement to the user and the servo (52) records its position which is directly proportional to the angle of mirror (48). Using these inputs in an algorithm, the computer sends a signal to the servo (52) that further moves mirror (48) so that the user is able to view the various vision patterns reflected onto mirror (48).

The position of the adjustable mirror prior to use is such that it reflects an infrared beam at an angle that would be taller than most users of the kiosk. When a person approaches or activates the navigation screen, the mirror sweeps the IR sensor beam downward. A signal is first received when the beam detects the top of the user's head. With knowledge of the distance to the user and the angle of the mirror when a signal is first detected, the mirror can be adjusted downward by an amount that would allow a user to see through the entire optical path of mirrors and view a displayed target at the other end of the optical path. It will be apparent that one or more additional distance sensors may also be used or no distance sensors used if user inputs their height information.

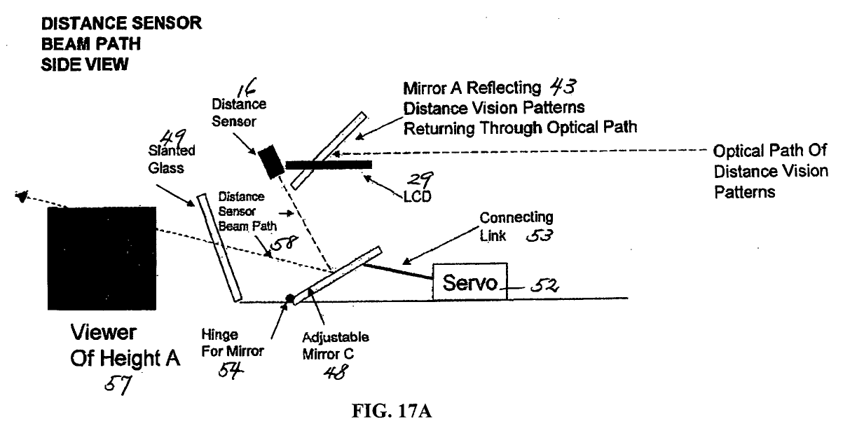

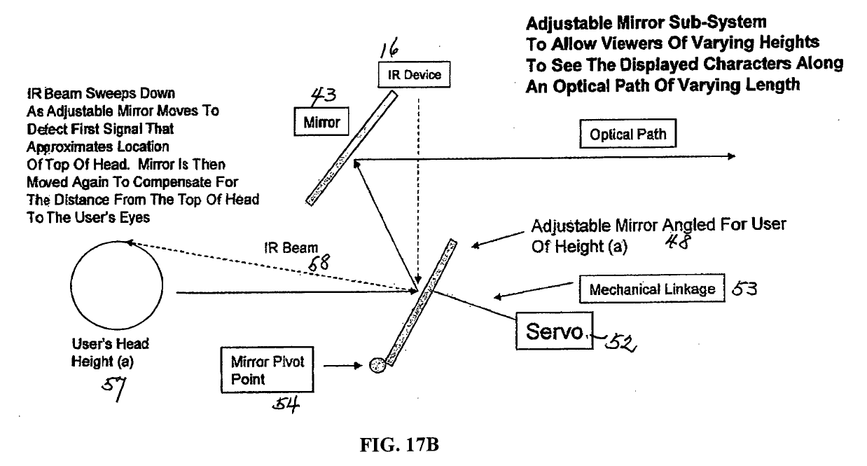

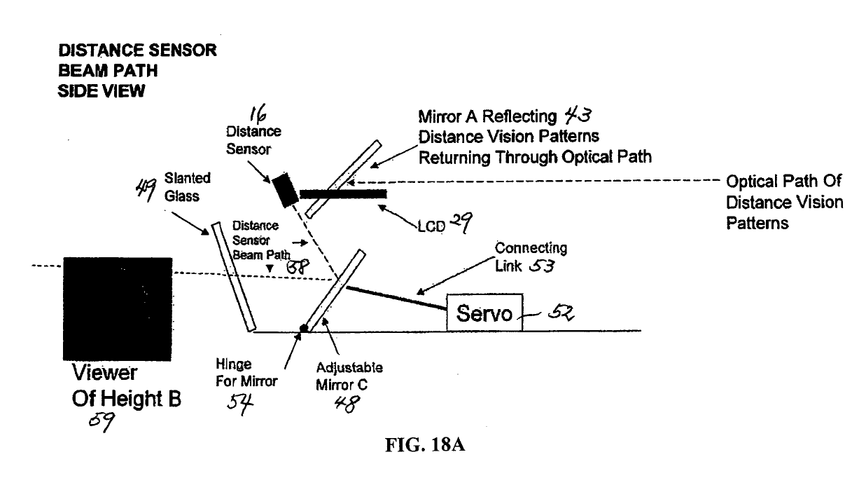

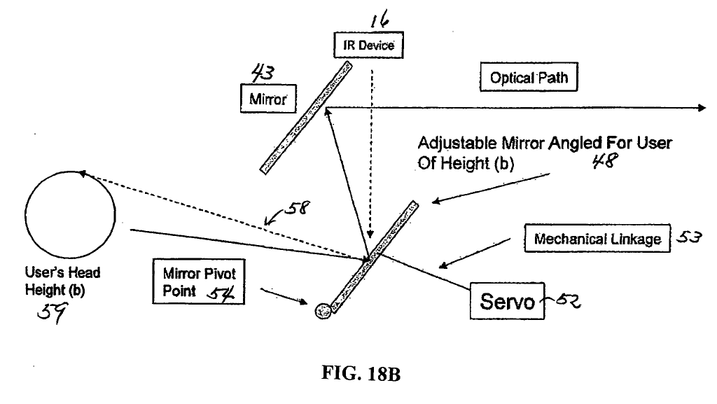

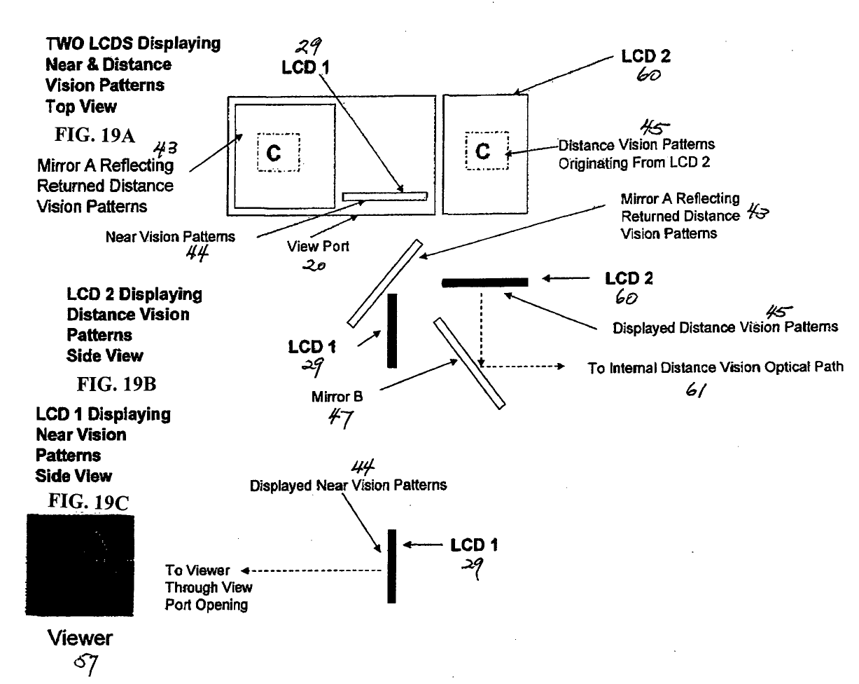

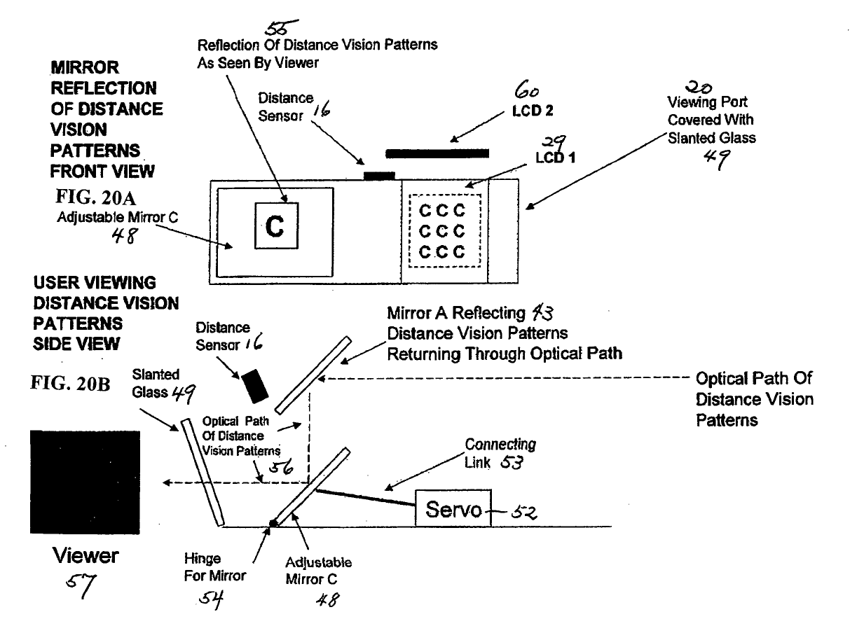

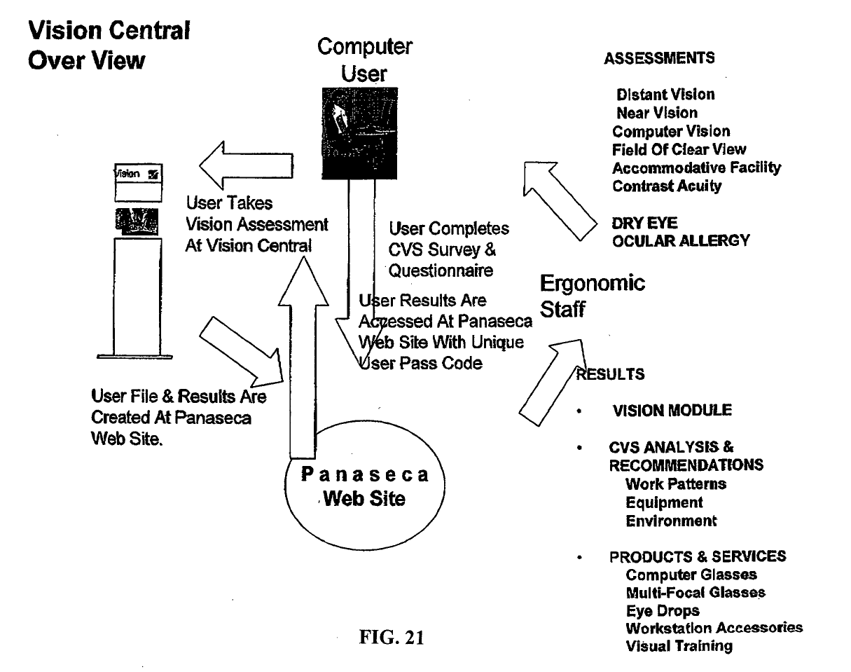

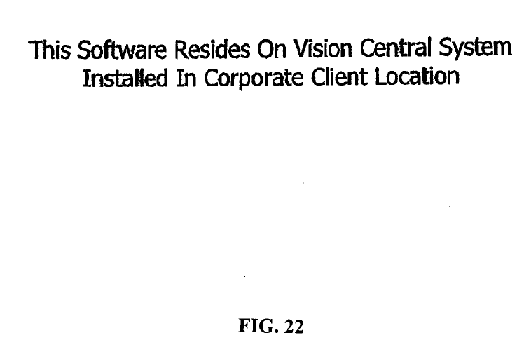

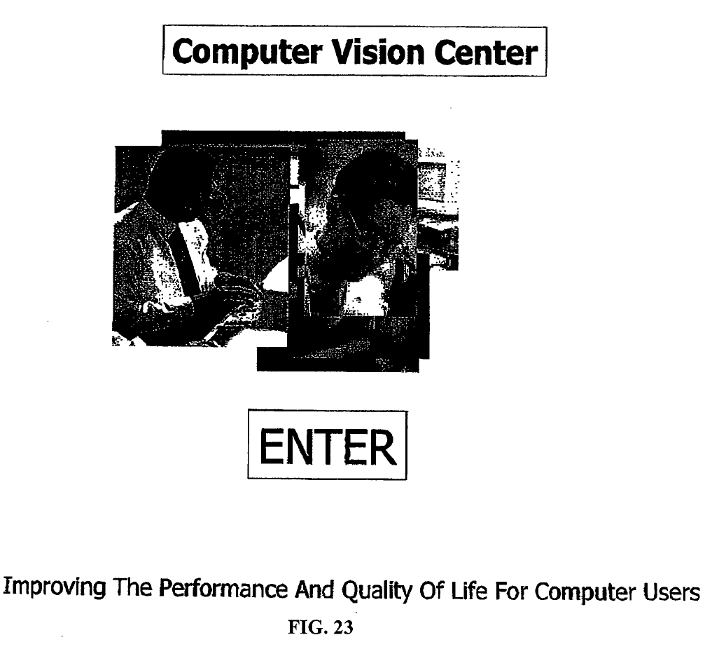

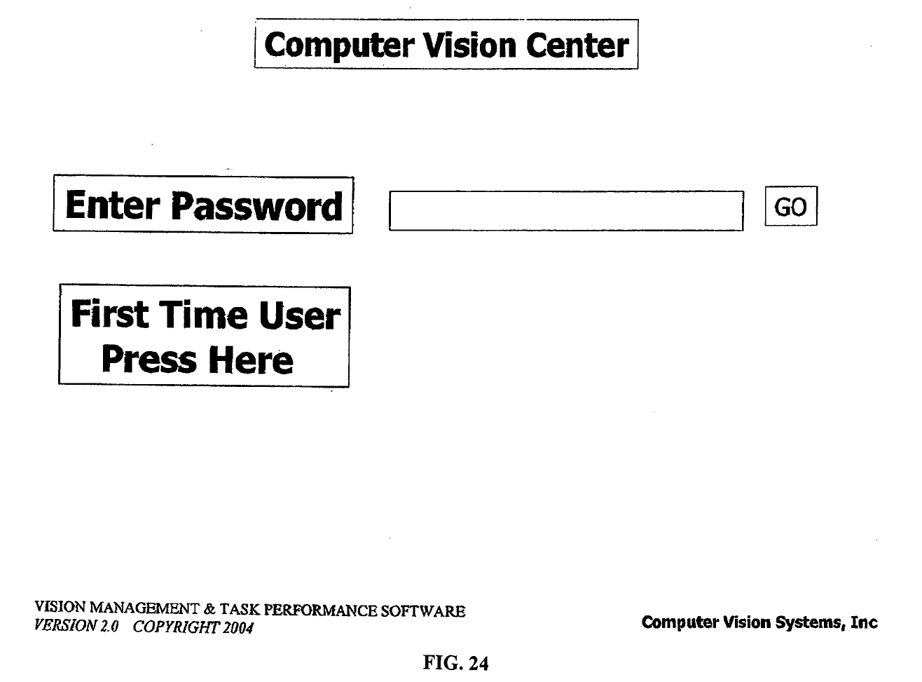

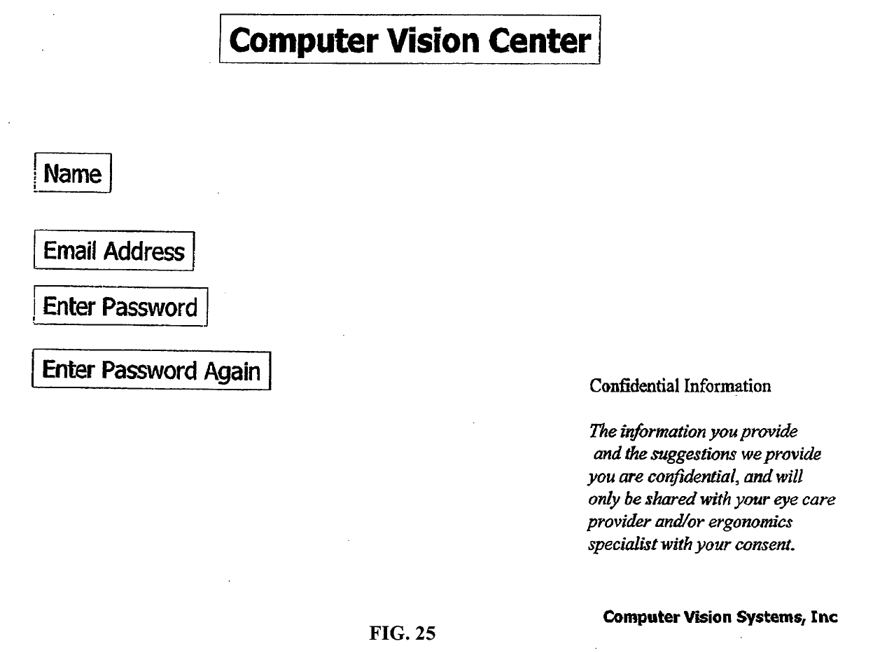

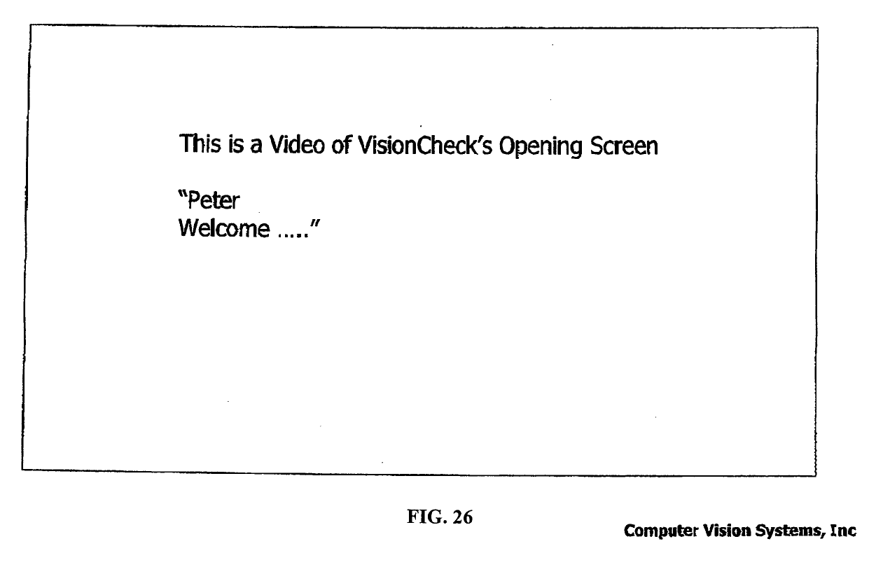

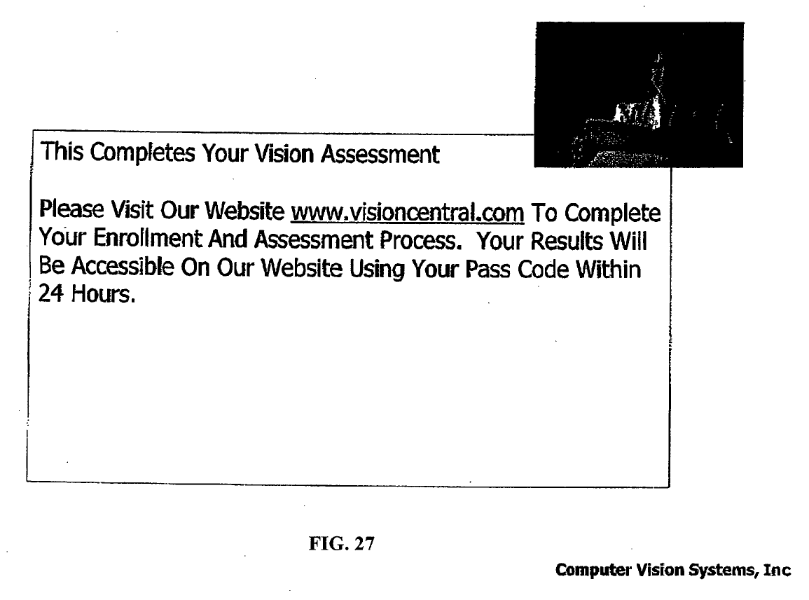

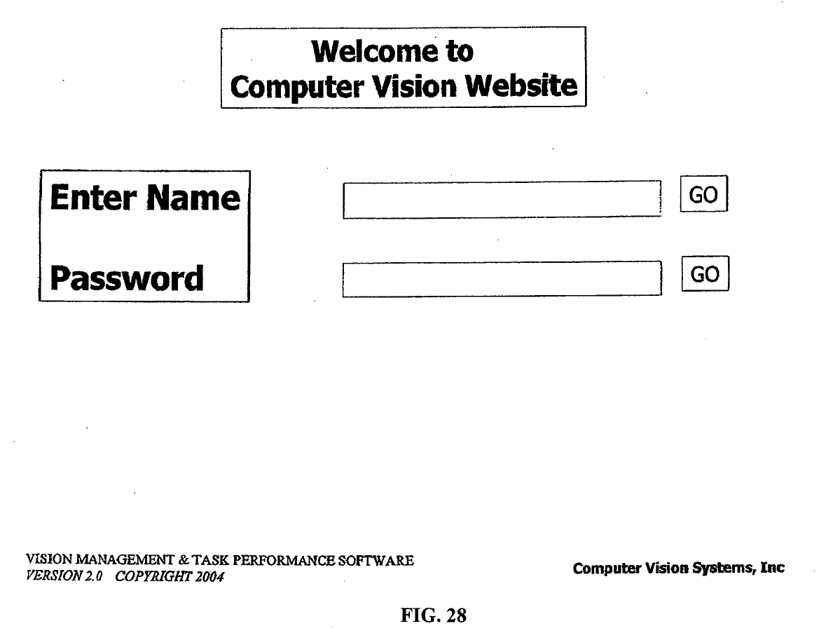

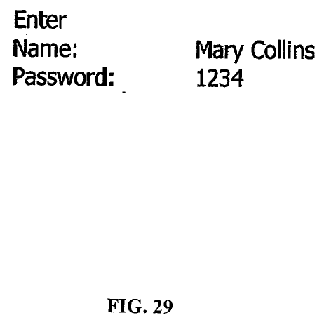

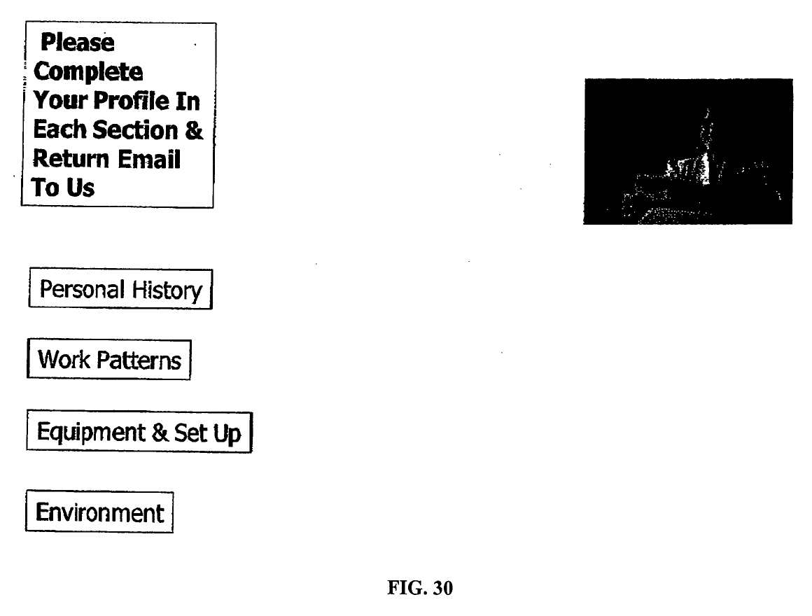

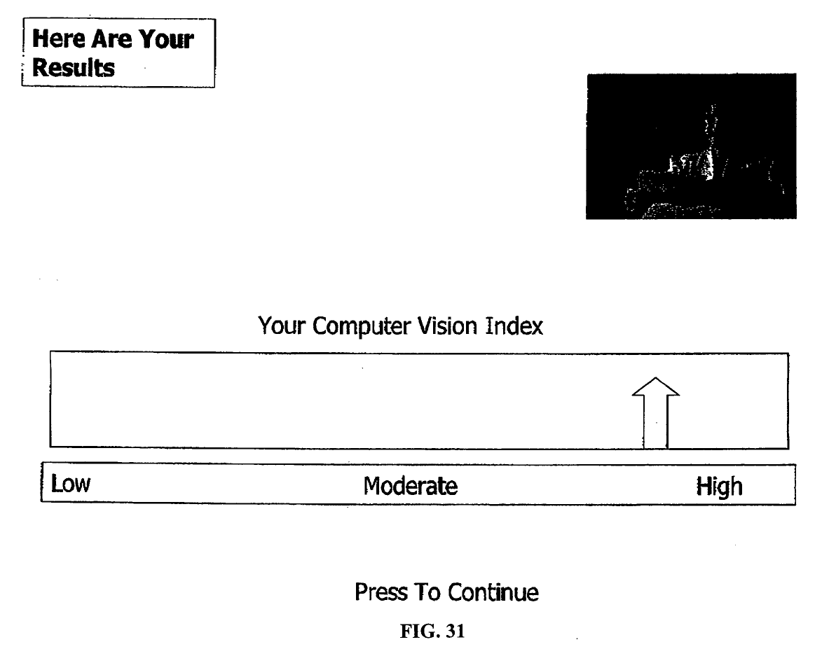

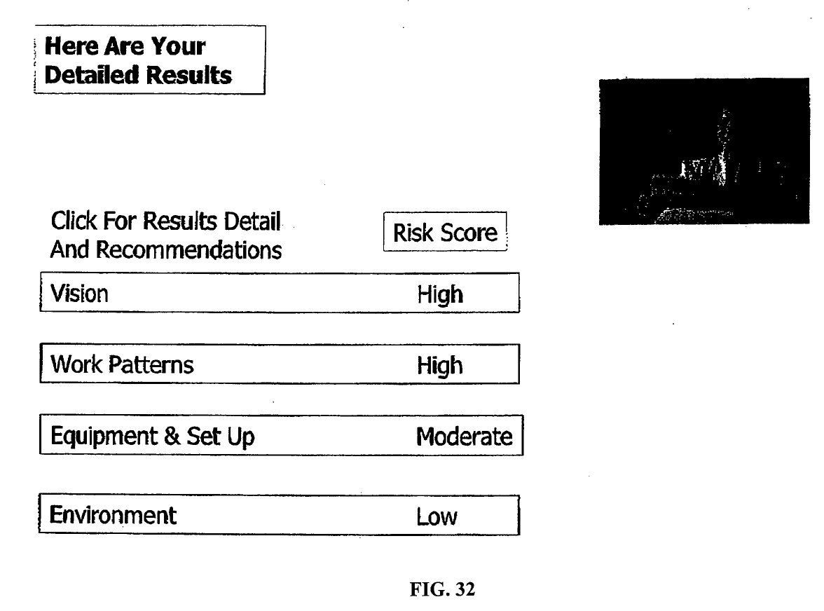

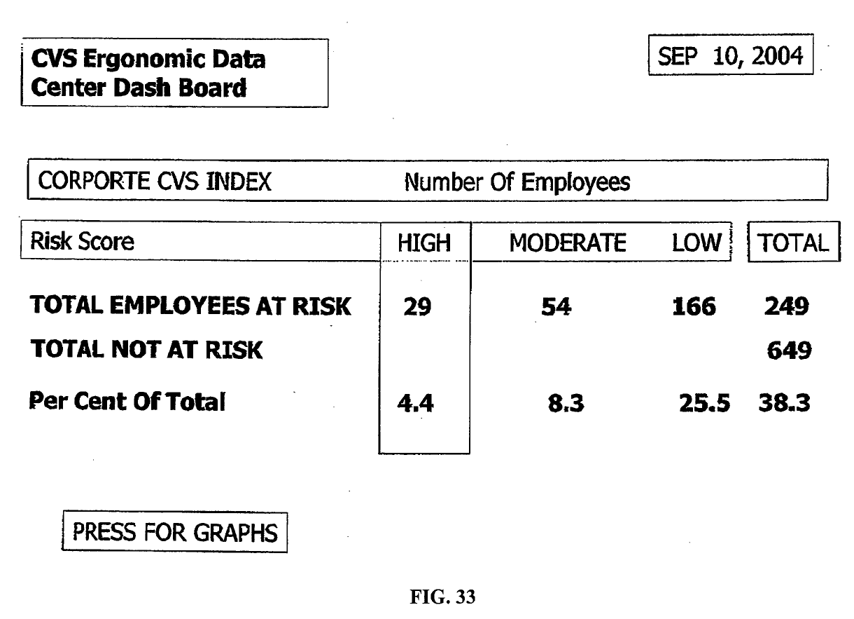

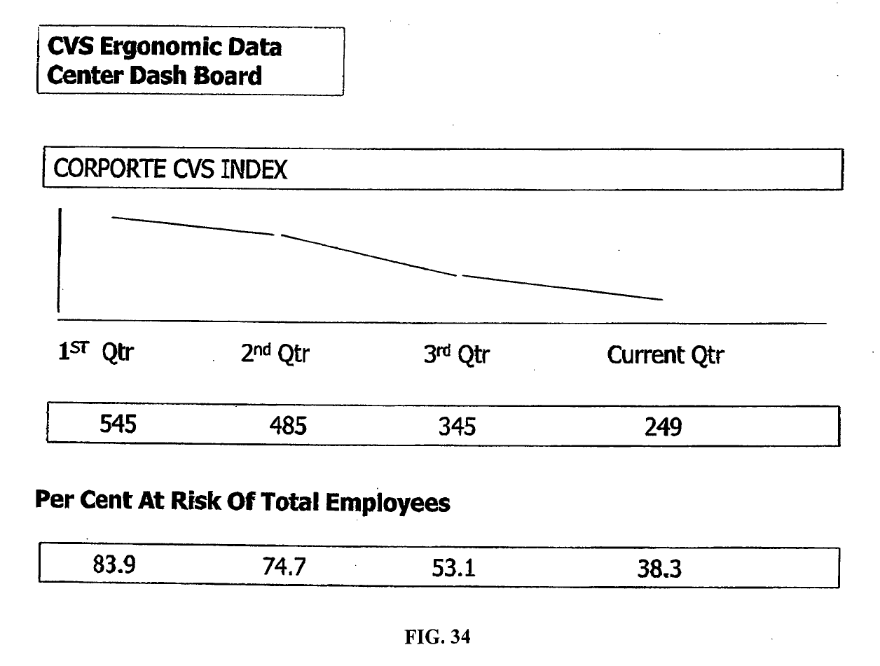

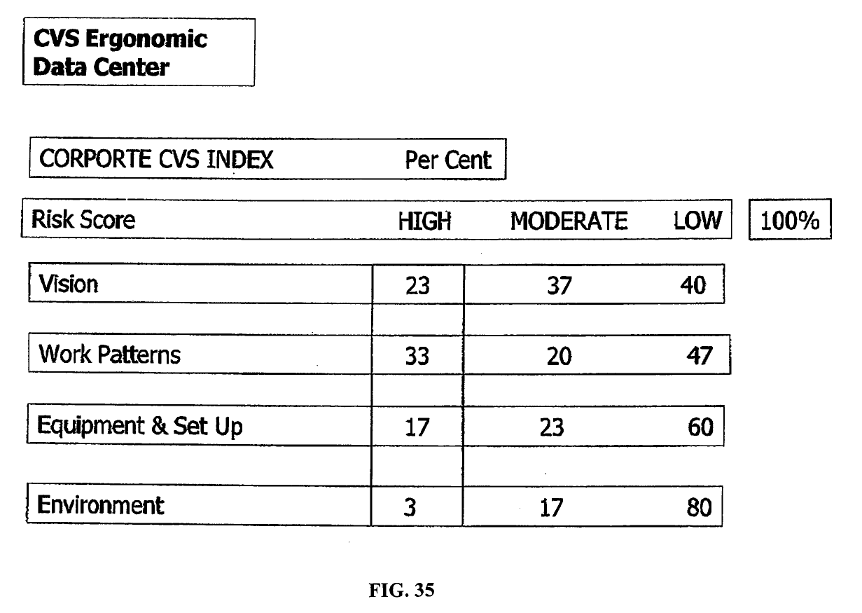

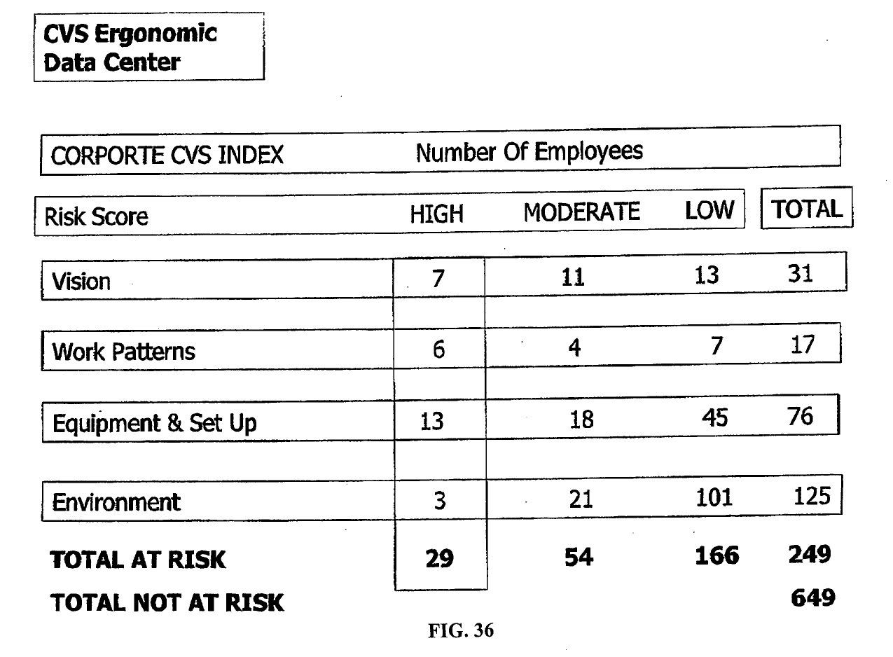

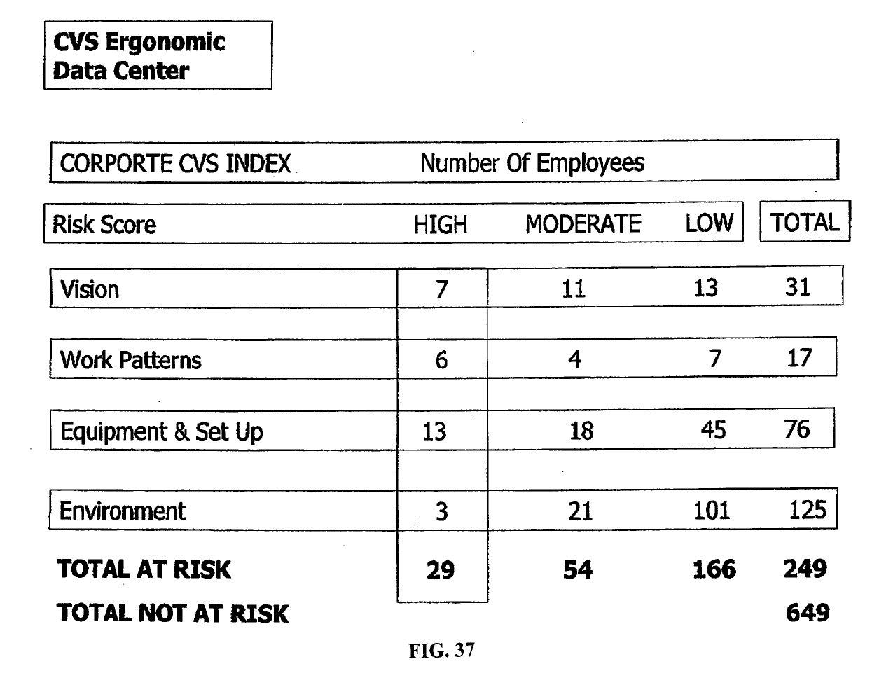

FIGS. 18A and 18B are diagrammatic representations showing the effect of change in angle of mirror (48) and the reflected distance sensor beam path (58) of a Viewer B (59) of height B. The height of Viewer B is lower than that of Viewer A in FIG. 17. An array of distance sensors or an optical distance sensor that locates the relative height and distance of viewer may also be used with or without mirrors to provide information to the servo (52) that adjusts mirror (48) to a viewing angle that allows a viewer to view the vision patterns reflected onto mirror (48).

FIG. 19A is a diagrammatic representation of a top view showing how, in one embodiment, two LCD's or other displays may be used for near and distance vision assessments. In this embodiment of the kiosk, LCD 1 (29) is mounted in a vertical position so a user or viewer (57) may directly view this display for near vision assessments. LCD 2 (60) is positioned in a horizontal orientation and displays distance vision patterns (45) onto angled mirror and into an optical path consisting of mirrors, or lenses, or combination of mirrors and lenses. Also shown is mirror (43) that receives a vision pattern from the optical path for display upon adjustable mirror (48).

FIG. 19B is a diagrammatic representation illustrating one possible path of displaying the distance vision patterns from LCD 2 (60) onto a mirror (47) and reflected the distance vision patterns (45) into an internal distance vision optical path (61). Also shown is the vertical position of LCD 1 (29) and the angled mirror (43) that reflects the distance vision patterns coming from the Internal Distance Vision Optical Path. FIG. 19C is a diagrammatic representation showing the vertical positioning of LCD 1 (29) and the direct viewing by a user (57).

FIG. 20A is a diagrammatic representation illustrating the reflected image of the distance vision patterns (55) on an adjustable mirror (48) and the direct viewing of near vision patterns displayed on LCD 1 (29) through the glass covered viewing port (49). FIG. 20B is a diagrammatic representation of a side view of mirror (43) reflecting the distance vision patterns returning through an optical path onto adjustable mirror (48) and viewable by user (57). A servo (52) and connecting link (53) allows the adjustable mirror (48) to be positioned so that users of varying heights and distances from mirror (48) may be able to see the displayed distance vision images.

FIGS. 21-37 are diagrammatic representations of the system used as an ergonomic vision tool in a home or corporate environment.

### DETAILED DESCRIPTION OF THE INVENTION

The inventors have discovered a system and method for assessing personal, medical, vision, hearing or other health or care needs of an individual. The inventors have further discovered a system and method of advertising, recommending or suggesting products and services to an individual, as well as advertising names and locations of service providers, retailers or manufacturers.

In one embodiment of the invention, there is provided a vision center kiosk for assessing vision. In another embodiment of the invention, there is additionally provided a vision center kiosk that provides information on vision care, vision care providers, vision related products and services.

The terms used herein are used in their ordinary, dictionary meanings and as understood by one skilled in the art. The present invention herein can be better in light of the meaning further ascribed to the terms below:

A “user” is one who uses the system of the present invention.

A “display screen” or “monitor” includes any conventional screen for displaying information such as a computer screen. A display screen can be a LCD or a touch screen, for example.

An “input device” includes any conventional input devices such as a mouse, a joystick, a touchpad, a keyboard or voice command, for example.

A “servo mechanism” is an automatic, closed-loop motion control system that uses feedback to control a desired output such as position, for example.

A “sensor” includes one that senses, detects, or determine distance, light, humidity, sound, motion, or image.

“Distant Vision” refers to a person's ability to view objects at a long distance.

“Near Vision” refers to a person's ability to view objects close-up.

“Intermediate Vision” refers to a person's ability to view objects that are intermediate between close-up and long distance.

“Computer Vision” refers to a person's ability to view materials displayed on a computer screen when positioned or working in front of a computer.

“Tear film breakup” refers to a condition in which a person's eye is drying out and the film of tear or moisture covering the eye starts to break up.

“Viewing distance” means the distance between a user's eyes and a display screen.

“Viewing angle” means the angle measured from the vertical that constitutes a comfortable and optimally legible reading angle for a user positioned in front of the display screen that allows the user to view the displayed information.

“Automatic” as it relates to adjustment or change in the materials being displayed on a display screen, for example, a change in size of characters being displayed, means an adjustment or change that is programmed into the present system and that does not require a user to manually adjust or change.

### System, Process, and Hardware

The present invention provides, in one embodiment, a system that includes one or more display screens, one or more input devices (such as physical or voice recognition, for example), a mirror system defining an optical path, an algorithm for conducting vision assessments and/or other assessments of health care needs, and optionally a microprocessor, memory, and/or, a printer. The system of the invention can be assembled in a number of different ways and such assembly is within the skill of ordinary persons in the art. The present invention is not limited to precise manner the components are assembled as described herein.

The present system is useful for many applications including: (1) assessing a user's vision and user's ocular health; (2) educating user regarding various vision problems and eye health issues; (3) suggesting products that may be beneficial to maintaining or improving user's vision and/or ocular health; and/or (4) providing coupons for vision recommended vision health services and products.

The present system is also useful for advertising products and services, such as vision-related or other products and services.

The present system further provides, in another embodiment, a system as above that is capable of assessing a user's vision and ocular health including, but not limited to, distant vision, near vision, intermediate vision, computer vision, central vision, field of clear view, accommodation, accommodative facility, contrast acuity, ocular allergies, the dryness of their eyes (mild, moderate, severe), blink rate (blinks per minute), tear film break up assessment.

The present system, in another embodiment, additionally includes a means for providing recommendations and potential remedies based upon assessment of a user's vision and ocular health.

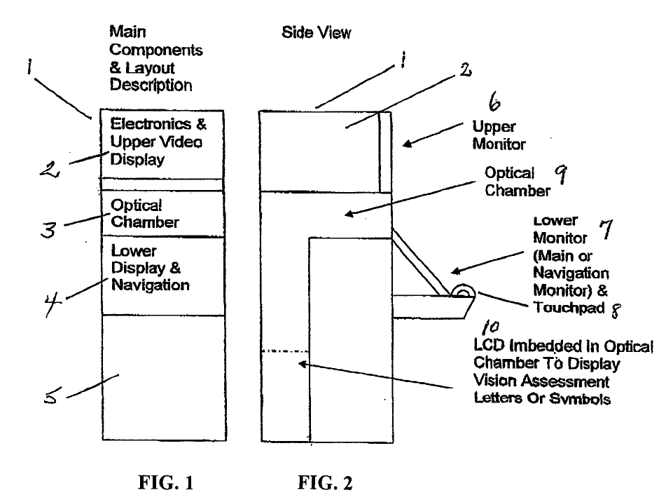

The above system may be embodied in a unit such as a kiosk shown in FIG. 1, 2 or 3, where a user can stand or sit in front of the unit. Alternatively, the system is provided as a desktop model or a wall-mounted model. Further, the system can be provided as a stand-alone unit or incorporated into a retail shelving system, such as one displaying vision care, for example, or any other products.

In one embodiment, the system contains one or more display screens, such as an LCD, a touch screen, or the like. For example, one LCD (split image) may be used. The display screen displays information (such as displayed on the Main Display) including a menu, navigation, questions, instructions such as operating instructions, educational materials, results of assessments, or products including recommended products, and/or services, including recommended services, for example.

In another embodiment, the display screen displays, for example, near or distance vision on LCD Display 1, and intermediate and distance vision, on LCD Display 2. The displays are viewed by the user through an array of mirrors so that the path of sight can be of any length ranging from several inches to several meters or more depending upon the placement of LCD displays and the number of mirrors used.

In one aspect of the invention, the invention provides two display screens, and the display screens are both LCDs, i.e., LCD Display 1 and LCD Display 2, one or both of which may be movable, for example, to create the exact path length related to a specific visual acuity of a user and target letter size depending upon where the user is standing or sitting in relation to LCD Display.

In one embodiment, an upper monitor can be used to display advertisements and/or educational information. The lower monitor can be a touch screen, for example, and can provide instructions to the user and allow the user to input information, navigate the program, receive assessment results and select coupons, for example. It will also be appreciated that a kiosk of the present invention may have no upper monitor or display screen and may have one or more lower monitors or display screens.

In one embodiment, the system comprises a computer. In one aspect, the letter sizes displayed on the display screen are adjusted dynamically by the computer and displayed to provide a specific visual acuity assessment at the distance the user is positioned while situated in front of the vision viewing window. If the user moves during a vision assessment, the letter sizes are automatically adjusted to maintain the correct acuity assessment (20/20, 20/30, 20/40, for example) given where the person is newly located.

In another embodiment, the present invention includes a method of allowing the user to manually adjust a Vision Display or viewing mirror for vision acuity test so user of any height can view the displayed characters.

In a further embodiment, the present invention includes a method and means for automatically adjusting a Vision Display (such as a LCD) based on the system sensing the user's height and using this height measurement to estimate the height of a user's eyes. In one aspect, the system includes a mirror that is automatically adjusted based upon user input of user's height, such as in a questionnaire format, or having the user identify a specific LED in an array of LEDs that would indicate the eye level of the user. Further alternatively, the user can manually adjust the mirror assembly, such as with touch screen buttons, joystick, mouse pad, and other similar input device.

The present invention further provides a viewing port that houses a system of lenses or mirrors for assessment of vision including near, intermediate or distance vision. The system of mirrors and/or lenses defines an optical path that facilitates adjustment of the image displayed to the height of the user or to the distance the user is away from the display.

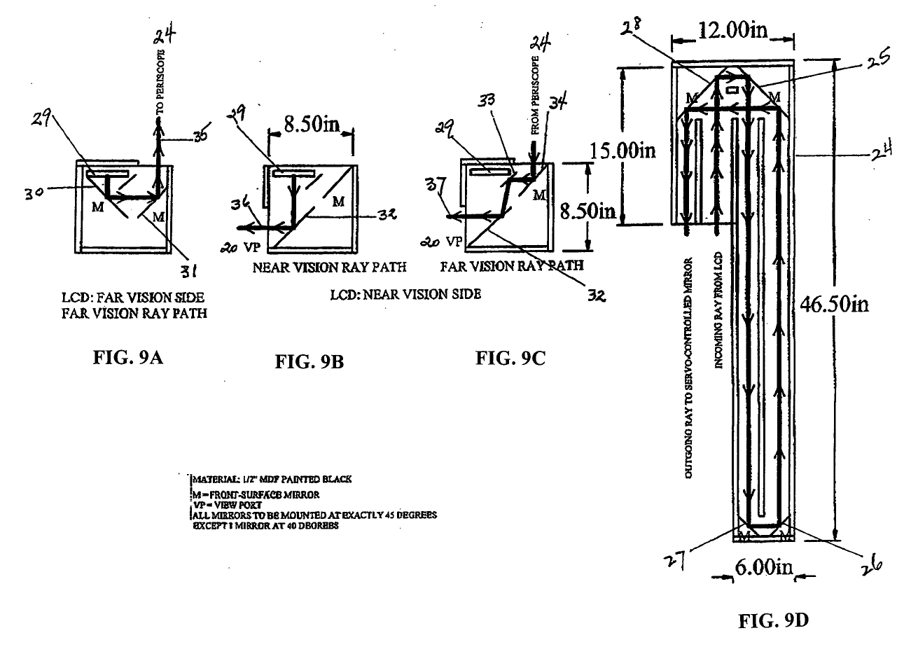

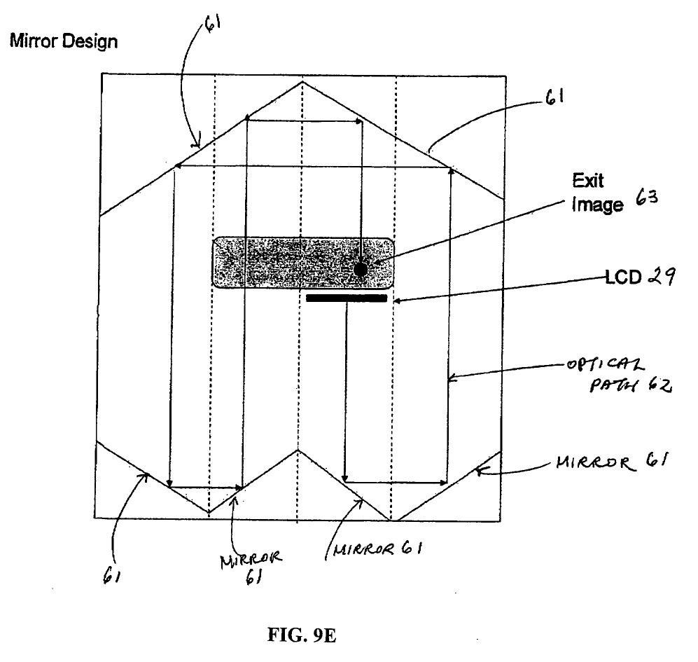

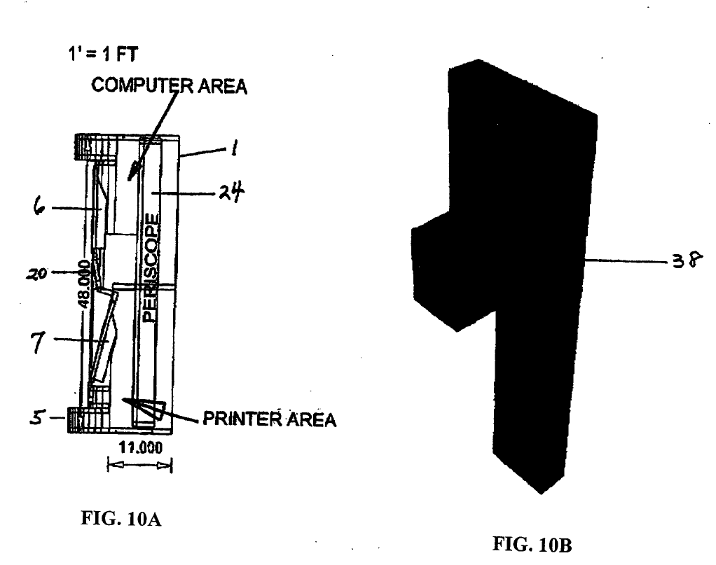

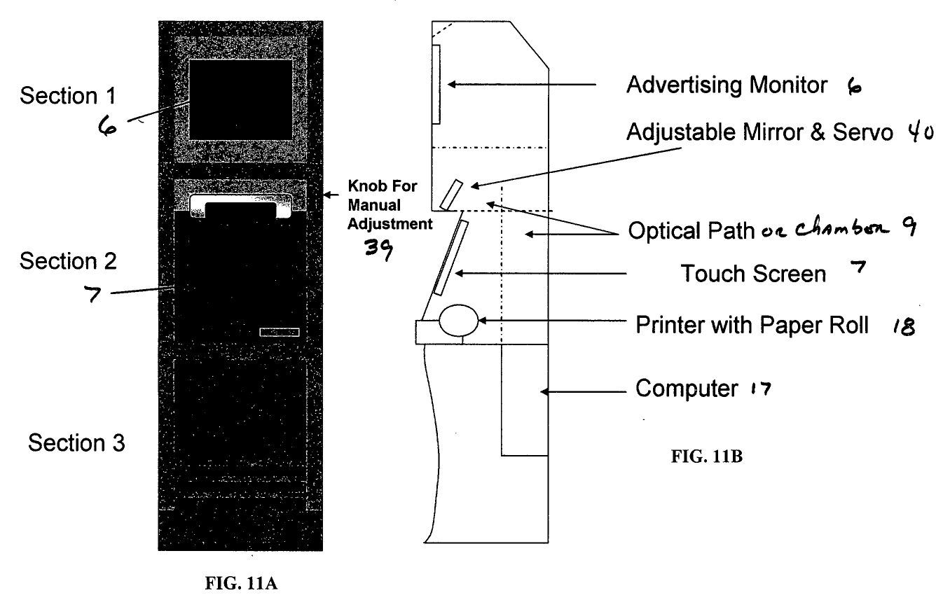

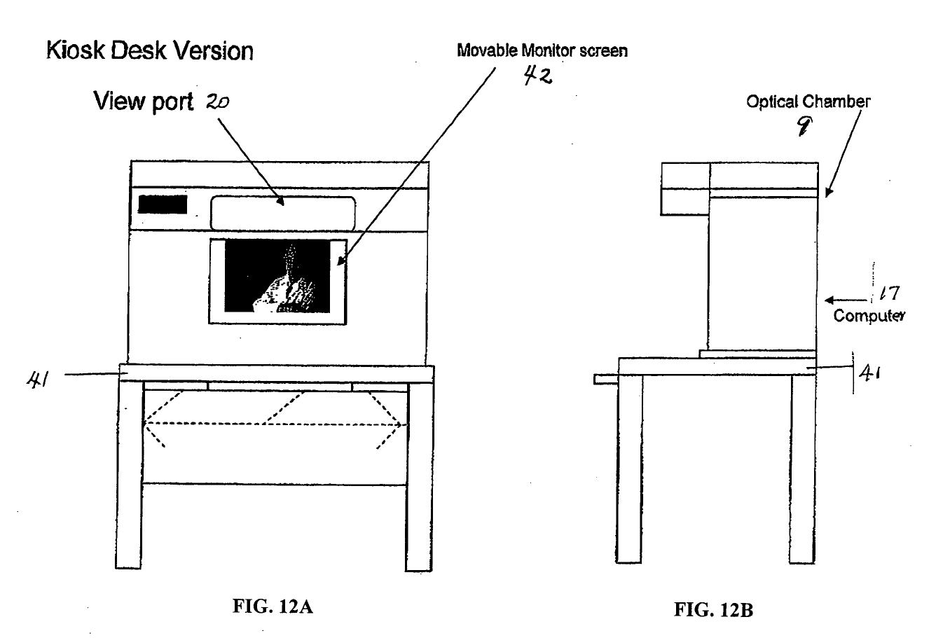

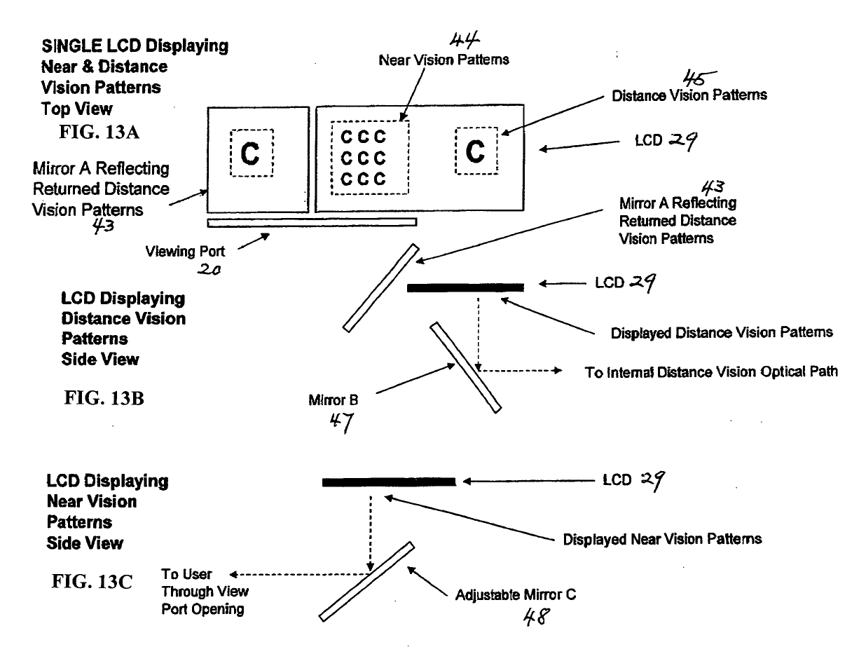

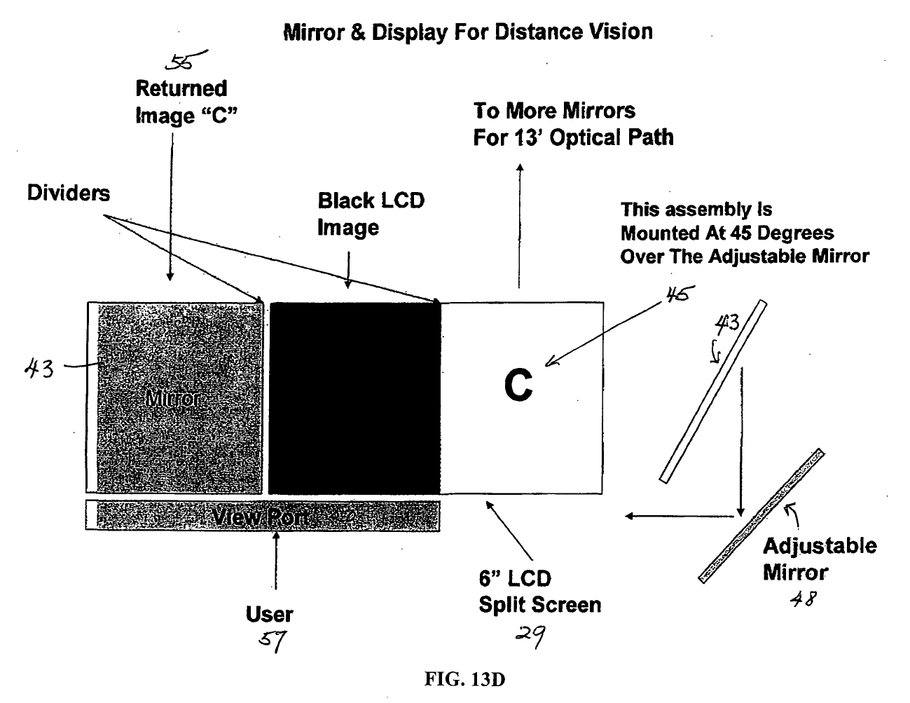

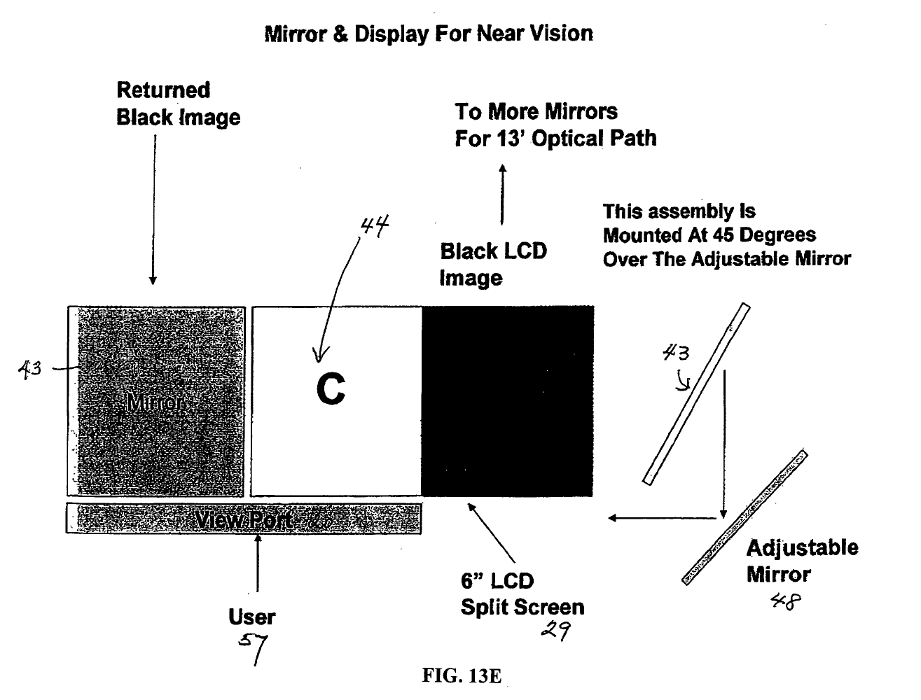

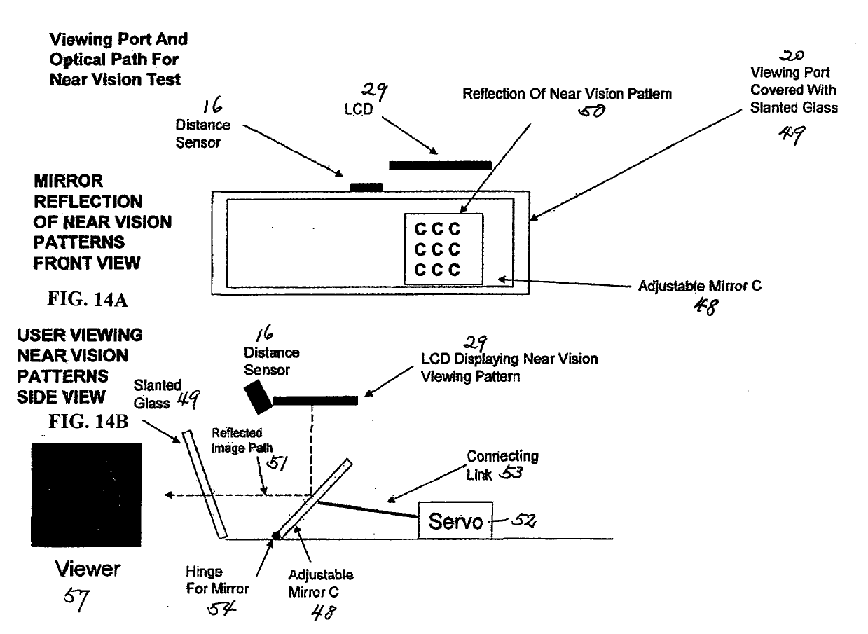

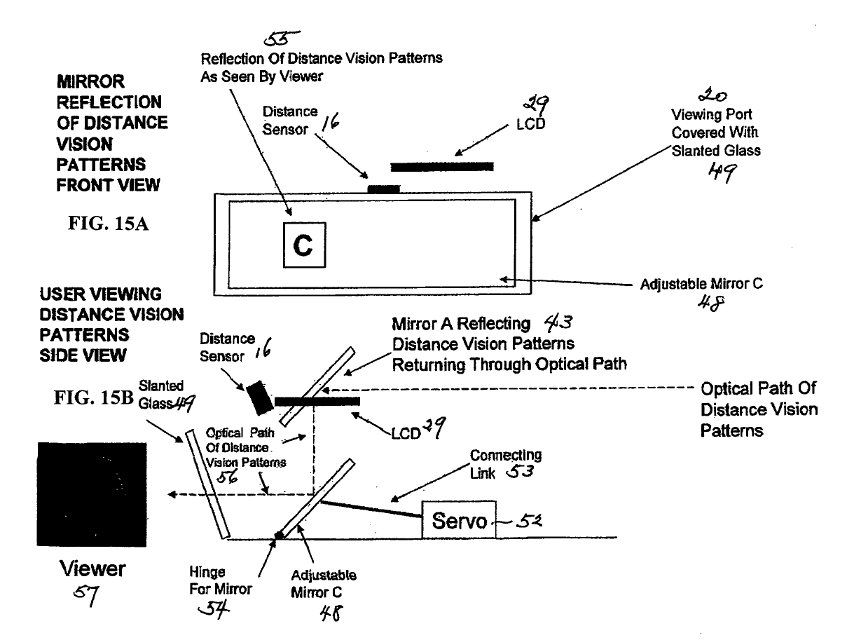

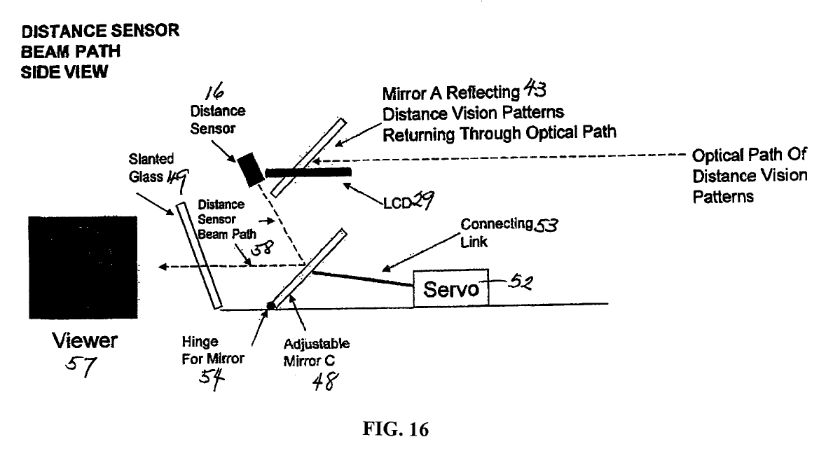

The optical path (23) exemplified in FIG. 8A and FIG. 9, is a depiction of any one of many optical path configurations that contain a display of vision patterns, and may include mirrors or lenses or a combination of mirrors and lenses that allow a vision pattern, such as a distance vision pattern, to be displayed at a predetermined distance such as the viewing distance, from the user.

The display, such as a LCD display, for example, within the optical path (23) may be fixed or movable. The LCD display may be fixed if the distance from the user to the LCD display originating the vision patterns approximates the viewing distance necessary to achieve a desired level of acuity given the size of the vision patterns originating from the LCD display. The size of the originating vision patterns may be made larger or smaller upon the fixed display depending upon whether the user's viewing distance becomes longer or shorter as sensed by the distance sensor(s). The LCD display within the optical path (23) may be movable to account for varied user positions or changes in a user's position while engaged in a vision assessment. The amount of movement of the LCD display varies directly with the position or movement of the user as recorded with the distance sensor(s). The size of the originating vision patterns also may made be larger or smaller upon the movable LCD display depending upon whether the user's viewing distance becomes longer or shorter as sensed by the distance sensor(s).

The viewing port opening (20) can be covered with glass or plastic that can be positioned at a negative angle to prevent glare if desired.

In another embodiment of the present kiosk, the adjustments to the viewing distance between the user and the display include a sensing of the user's position with a distance sensor or image sensor and instructing the user to move into a position that provides the desired viewing distance.

In yet another embodiment, the present system is provided with a distance-determining means for determining user position and distance relative to the display screens, such as, Displays 1 and 2. Distance-determining means include sensors, including but not limited to infrared, optical (such as a camera), or acoustic sensors, markings on the floor, or the positioning of an input device such as a joystick, mouse, trackball, etc. that places the user in a known distance region when user can grasp or use such input device.

In still another embodiment, the present invention includes a system as above with one or more of: a camera, an infrared source, and software, where the software is so configured or programmed to enable the identification of the eye region of a user and determines user blink rate (in number of blinks per minute), completeness of blink, and the vertical size of the eye aperture (such as opening of the eye), and pupil size.

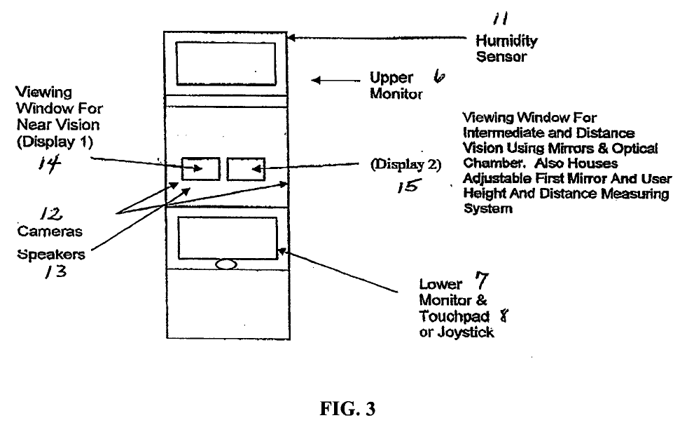

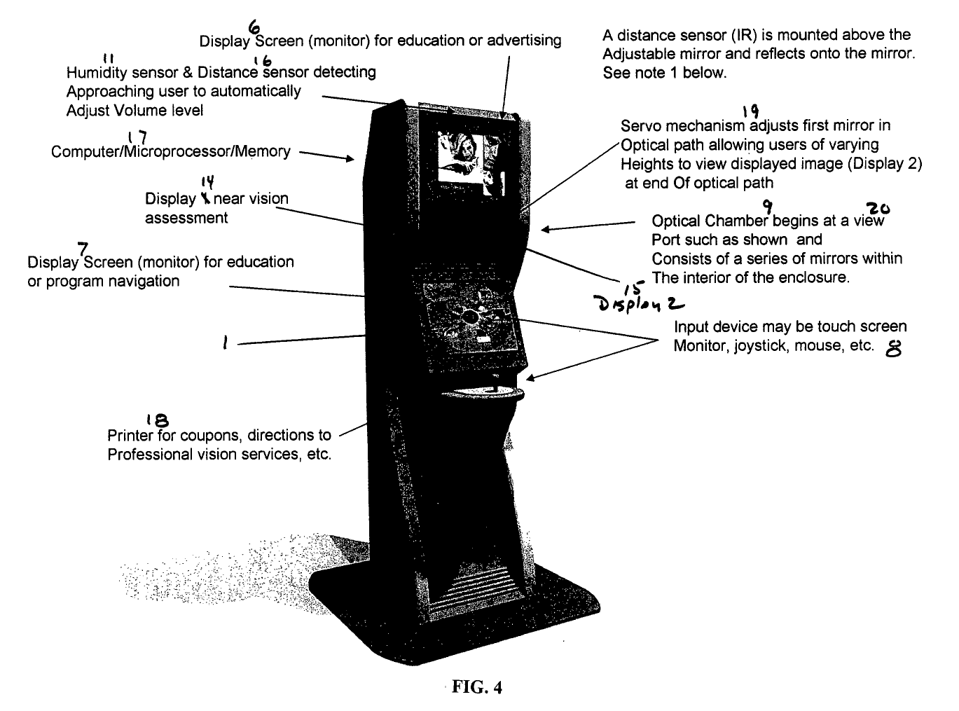

In another embodiment, the present invention includes a system as above with one or more displays, such as an LCD, as shown in FIG. 3, for example, as Display 1 and Vision Display 2. In one aspect, alpha-numeric characters are shown on the display at designated sizes so that a person's vision can be assessed from viewing the displayed characters from a known distance between the display and the user. Randomly rotating a letter “C” is one embodiment of assessing visual acuity where the user identifies the direction of the ‘opening of the C’ such as right, left, up or down. The size of the ‘C’ corresponds to a specific visual acuity at a known user viewing distance.

In a further embodiment, the present invention provides a system as above that includes one or more of a Main Monitor Display and another Vision Display. The Main Monitor Display or another Vision Display is movable upwards or downwards and forward or backwards, so as to change the viewing distance of the user.

In another embodiment of the invention, the present system enables the user to remain at a specified viewing distance from the displayed characters, such as guided by on-screen commands or other user feedback techniques.

In a further embodiment, the present invention provides a system and method as above that include a means for automatically changing the size of the displayed characters based on the user's viewing distance. Optionally, the system and method also include a means for automatically adjusting the size of the displayed characters taking into account user movements and variances in the user's distance from the display to achieve a specified level of acuity, such as 20/20, 20/30, 20/40, etc.

In yet a further embodiment, the system as above additionally includes a software program that is configured to record automatically the response time as to how long a person takes to record their response to the displayed characters. The system optionally provides a rating system, such as a scale of 1-10, or a qualitative scoring of mild, moderate, severe, such that a user of the system can indicate the level of ‘blur’ in reference to the displayed characters at a given level of acuity. These measures can be used to fine-tune a person's level of acuity. A longer response time and a higher blur rating indicate more difficulty in seeing the displayed characters versus a quick response time and lower blur rating. The response time can be age adjusted if the user inputs user's age. This data can be tracked over time to indicate meaningful changes.

In yet another embodiment, the present invention includes the system as above, where the input device is a touch-screen LCD, trackball, a mouse, a keyboard, or voice recognition or other input device. With such input device, a user can record answers to a questionnaire or indicate the direction of the displayed ‘C’ or other characters used to assess visual parameters. In another embodiment, the system optionally include an eye tracking system in which the user indicates the direction of the opening of a displayed ‘C’ or other characters by moving his or her gaze in that direction. For example, with the displayed ‘C’ shown here, the user would move their gaze to the right.

In a further embodiment, the present system as above includes a light sensor that senses the intensity of ambient light and any light directed onto the surface of the displays. The output of the light sensor may be used to ascertain optimal location and orientation of the vision center as one in which there is no glare or high ambient light on the display screens.

In yet another embodiment, the present system as above includes a humidity sensor that senses the ambient humidity.

In still another embodiment, the present system is situated and used in a public area such as pharmacies, optical retail stores, medical centers and hospitals, optometrist and ophthalmologist offices, corporations, schools, and other public places.

In yet another embodiment, the present system is situated and used in the offices of opticians, optometrists, and ophthalmologists.

The present system, such as in the form of a Vision Center, may be internet enabled to provide central data collection, analysis, and reporting of data from each location. The present system, in one embodiment, provides for downloading of new advertising or assessment content to each Vision Center through use of the internet.

In another embodiment, the above system includes a means by which the user data can be emailed to the user, an eye-care provider or other vision service.

In still another embodiment, the above system includes a means by which the user can input user's email address to obtain further information about vision and related health issues, products, and services.

The present system, in another embodiment, includes a means for printing coupons on recommended or featured products and services that may be related to the user assessment.

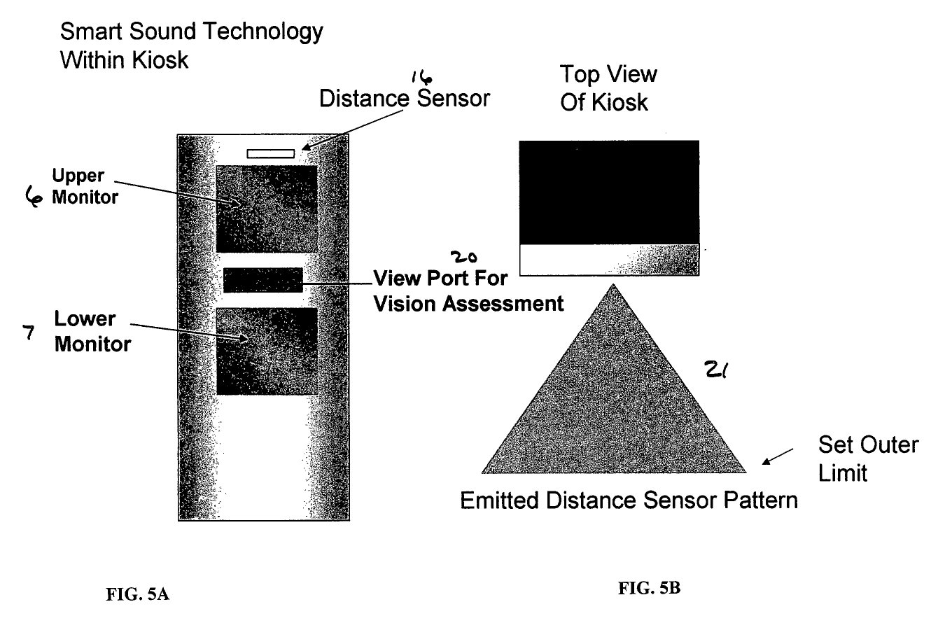

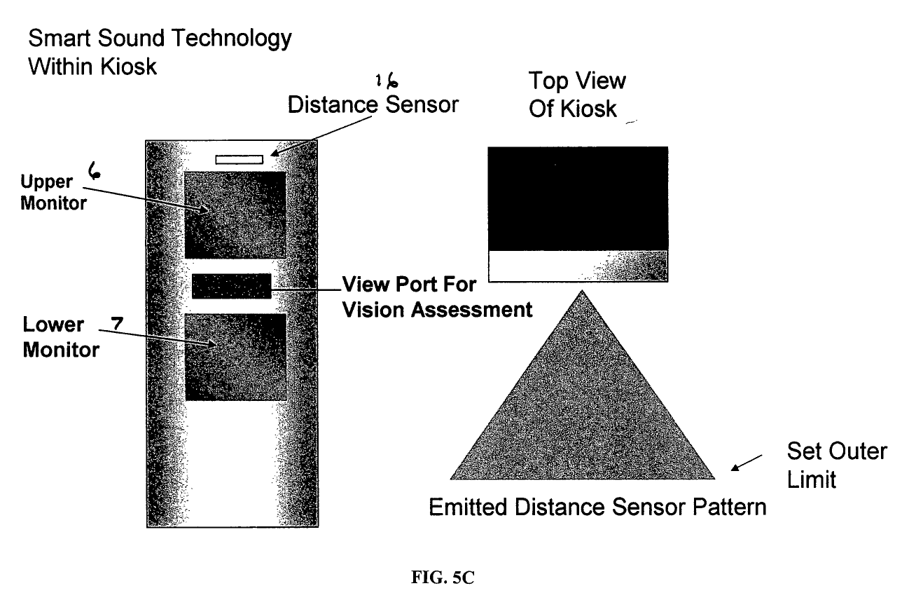

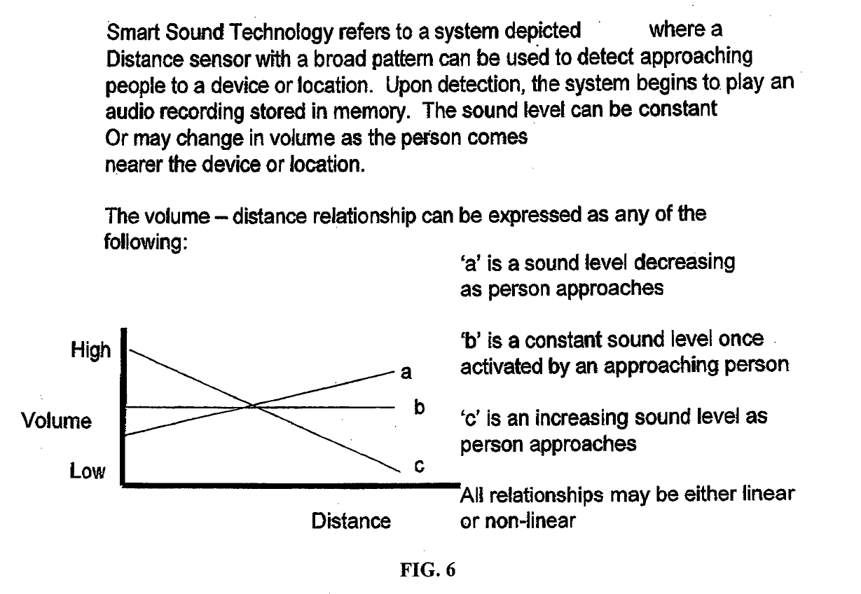

In still another embodiment, the system as above includes a sound system, such as a smart sound technology, where the volume of the sound is proportional to the distance between user and the display screen as shown in FIG. 5 and FIG. 6. Thus, for example, when the user is farther away, sound from the system is minimal and when the user is closer, sound from the system is increased. The distance between user and the display screen is detected by a distance sensor or an image sensor.

In another embodiment, the system as above with the sound system is provided with a constant sound level once a user approaches within a specified distance to the system.

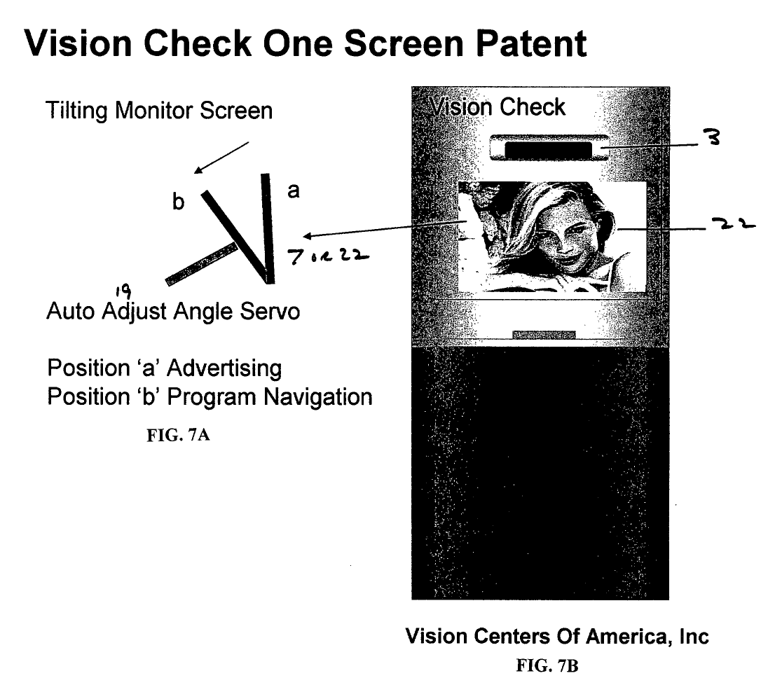

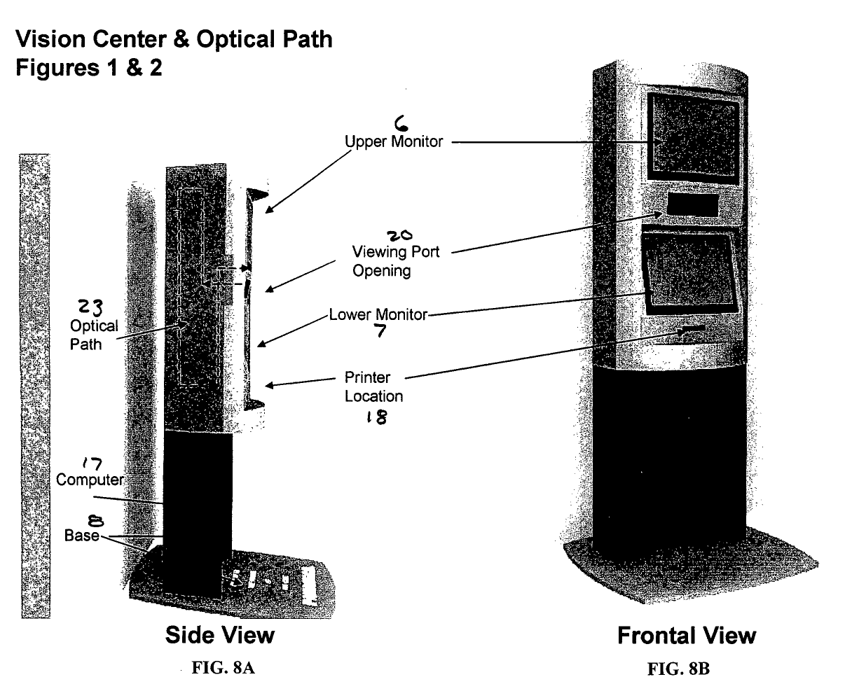

In yet another embodiment, the system as above includes a servo mechanism for automatically adjusting an optimal viewing angle as shown in FIG. 7.

In using the present system a user would look into the viewing port opening to take the distance and near vision assessments. When the system is equipped with a printer, the printer may be positioned to print user results, educational or other information and coupons.

The present invention can be illustrated by the following Examples which are included for illustrative purposes and should not be interpreted as limiting, as the present invention is limited only by the appended claims.

All references to patents, patent applications and journal articles are incorporated herein by reference in their entireties, including the citations referenced therein. Further, as used herein, the singular includes the plural such that reference to “an input device,” for example, includes more than one input device, and reference to “a product,” for example, includes more than one product.

### EXAMPLE 1

### Near, Intermediate, and Distance Vision Assessment

All measurements are made with a person wearing their full optical correction in place, such as, glasses or contacts. The system records the viewing distance of the user and adjusts the size of the “C” or other displayed character to achieve a specified level of acuity, such as 20/20, 20/30, 20/40, etc. If user moves, the size of the displayed characters may optionally automatically adjust to compensate for the change in viewing distance or the system may notify the user that he or she has changed the viewing distance, and requires the user to move into the desired viewing range to continue the vision assessment. On screen commands and responses can direct user to the correct viewing distance.

The user begins the vision acuity assessment by some input means such as a touch screen, mouse, joystick, voice command, etc. A “C” or an array of “Cs” or other character or characters are displayed on the Vision Display Screen. With an input means, such as a touch screen monitor, joystick, the user indicates the direction of the displayed character(s) or identifies them by matching them to an enlarged character(s) of the same design or orientation. The characters will be displayed for a specified length of time and randomly rotated.

### EXAMPLE 2

### The System Used as a Screening Device

The system may be used as a visual acuity screening device by displaying a specified size of character(s) associated with the screening level of acuity desired. For example: The system may display for intermediate and near vision acuity a sequence of five “C's” or an array consisting of nine C's shown in random order. The size of the C's may be set for one visual acuity such as 20/20, 20/30, etc. All four directions in which the C's are facing are randomly displayed in the first four displays. User Passes if user misses none or one. User Does Not Pass if user misses two. If user misses one in the first four displayed C Arrays, the fifth C or C Array should be oriented in the same as the one missed. Example of C array is shown below.

$$\begin{matrix}C & C & C \\ C & C & C \\ C & C & C\end{matrix}$$

This procedure may assess each eye of the user individually (monocular vision assessment) with one eye covered with the hand or closed, or both eyes open (binocular vision assessment).

### EXAMPLE 3

### The System Used as Acuity Measurement Device

The system may be used as an acuity measurement device by identifying the smallest character(s) out of a population of varying sizes of character(s) that the user can see at a given viewing distance. For example: The system may display a series of different sized characters. Each size may be shown a number of times. If the user correctly identifies all or nearly all of the character(s) or their direction, the next smallest size is displayed and the process repeated until the assessment ends or the user incorrectly identifies a specified number of the character(s) or their direction. If the user correctly identifies the smallest displayed character, then the acuity of the user is this acuity level or better. If the user incorrectly identifies a given number of characters at a given acuity level, then the acuity of the user is the next highest acuity level.

### EXAMPLE 4

### Computer Vision Assessment

All measurements are made with a person wearing their full optical correction in place, such as glasses or contacts. The system directs the user to (1) input user's usual viewing distance (inches, feet, centimeters, etc.) to the computer monitor when using a computer or the display screen, or (2) move into a position relative to the system's monitor screen that approximates their computer monitor viewing distance. Distance sensors within the system record the viewing distance when the user indicates user is at his or her usual viewing position.

### EXAMPLE 5

### The System Used as Screening Device

With the viewing distance known from the above procedure, the system may be used as a Computer Vision acuity screening device by displaying a specified size of character(s) associated with the screening level of acuity desired, such as 20/20, 20/30, etc. The vision screening assessment procedure may follow that described above.

### EXAMPLE 6

### The System Used as Acuity Measurement Device

The system may be used as a Computer Vision acuity measurement device by identifying the smallest character(s) out of a population of varying sizes of character(s) that the user can see. With the viewing distance known from the above procedure, the size of the displayed characters can be changed to correspond to a specific level of acuity at the known viewing distance. The acuity of the user is obtained by the user identifying the smallest character(s) out of a population of varying sizes of character(s) that the user can see on the Vision Display or monitor screen. The vision screening procedure may follow that described above.

### EXAMPLE 7

### Field of Clear View

Users wearing multi-focal lenses such as bi-focal, tri-focal, or progressive lenses, often have difficulty seeing the entire computer monitor screen. They usually compensate for this by moving their head so they may see through a different portion of their multi-focal lenses. This may lead to neck and upper back strain and reduce their productivity by excessively moving their head. The objective of the assessment for Field Of Clear View is to ascertain for wearers of multi-focal lenses the portion of the computer monitor screen the user can comfortably view without moving their head. This assessment also checks the segment heights of the multi-focal lenses to ensure they are in proper alignment.

The following describes an example of a procedure and narration, but not necessarily the only procedure and description, depicting the assessment of the Field of Clear View:
The system directs the user to (1) input their usual viewing distance (inches, feet, centimeters, etc.) to the computer monitor when using a computer, or (2) move into a position relative to the system's monitor screen that approximates user's computer monitor viewing distance. Distance sensors within the system record the viewing distance when the user indicates that he or she is at his or her usual viewing position. The test is conducted mono-ocularly with the user covering or closing one eye. Both eyes are tested in this manner.
Example Narration:
You will now see a page of text on our computer monitor with a black dot in the center. Always look at the black dot. Cover one of your eyes, but do not close this eye. With your open eye look at the black dot. We will move a line across the text slowly in the Upward Direction. We would like you to tell us when the moving line reaches a portion of the text that you notice begins to blur. Press the top button on the joy stick when this occurs.
We will then move the line downward, then to the right, and left. Each time we begin moving the line, please indicate by pressing the top button when the moving line reaches a portion of the text that begins to blur. To be accurate, you will need to always look at the black dot, not the moving line. Press the top button to begin the test or to restart.

Analysis. The System calculates the Field Of Clear View as the area clearly seen by the user without moving their head and depicted as the area within the boundary of the upper, lower, right and left lines the user has delineated. The result is expressed as a percentage by dividing the Field Of Clear View Area by the total area of the monitor screen. The analysis compensates for different sizes of monitors of the users. A high percent result indicates the user may work at the computer without excessive head movements to view the monitor screen. A lower percent result possibly indicates excessive head movements required to view clearly all portions of the monitor screen. The system may suggest that the user obtain a new multi-focal lens prescription that allows a greater portion of the monitor to be viewed or special glasses specifically designed for computer use.

It may occur that the two areas of the Field Of Clear View (one for each eye) may not vertically align with each other. This may indicate that the segment heights of the user's multi-focal lenses are not properly aligned. This may also occur with an optical aberration in the lens. This may lead to eye strain, headaches, and possible blur when performing near or immediate distance tasks such as viewing a computer monitor screen. The system may suggest to the user a professional eye examination to correct any disparity between segment heights of their lenses.

### EXAMPLE 8

### Central Vision Assessment

All measurements are made with a person wearing his full optical correction in place, i.e. glasses or contacts. The Central Vision Assessment relates to the health of the interior of the eye, and in particular, the health of the retina. Assessment will help determine the user's ability to see entire displayed images and displayed images without distortion, such as that appearing on a computer monitor screen.

The assessment is performed using a Grid of lines in the horizontal and vertical direction with a dot in the center. This method can be employed with white lines on a black background, black lines on a white background, or certain colors that produce a reasonable contrast between lines and background. The system will ask the user to assume a position at a relatively close distance to the monitor screen. This distance may vary depending on the size of the monitor screen used. The distance sensor, aligning LEDs or other means physical means such as a positioning rod will indicate to the user when he or she is at the correct viewing distance. The system will ask the user to focus on a dot in the center of the grid for the entire duration of the assessment. The assessment will be performed mono-ocularly.

### EXAMPLE 9

### The System Used as a Screening Device

Questions regarding what the user sees will be asked. Such questions may include, but not limited to the following:
Do they see the dot in the center of the grid.
Do they see all corners and sides of the grid
When they look at the center dot, do they see any missing lines, or distorted or wavy lines

Analysis. A ‘yes’ to any of the above questions may indicate the user has a central vision problem and the system would recommend him to see an eye care professional for an eye examination.

### EXAMPLE 10

### The System Used as Measurement Device

The system can be used as a measurement device by asking the user the above questions and if user answers ‘yes’ to any question, user is to indicate the areas of the grid that are not seen or not seen clearly. This can be accomplished by a touch screen or other input device that would allow the user to accurately indicate specific sections of the grid he has difficulty clearly seeing.

The Central Vision Assessment can be made more sensitive to each individual whether used as a screening or measurement device by changing the brightness of the grid lines relative to the background. A method of accomplishing this is to ask the user to diminish the brightness of the grid lines until the grid lines can no longer be seen. The user then increases the brightness of the grid lines until the grid lines are just perceivable. The user then begins the assessment as discussed above.

### EXAMPLE 11

### Contrast Acuity Assessment

All measurements are made with a person wearing their full optical correction in place, i.e. glasses or contacts. A person's visual acuity using high contrast acuity charts does not indicate nor predict how well the person can see in lower lighting conditions. The Contrast Acuity Assessment helps to determine a user's level of visual acuity at various levels of lowering contrast between the “C's” or other alpha-numeric characters and the background upon which they are displayed. The assessment involves displaying a series of characters of varying contrast to the background to determine the smallest character size a user can see at a specific contrast.

### EXAMPLE 12

### The System Used as Screening Device

A Contrast Acuity Assessment can be employed using the size of the displayed character(s) used in any of the above screening assessments with varying degrees of contrast. The contrast ratio between the displayed character(s) and the background can range from 100% contrast to 0% contrast, but practical assessment time limits may require that a limited number of specific levels of contrast be displayed. These may be contrast ratios of 50%, 20% and 5% or other such combination within the range of 100 to 0%.

A user will be asked to identify the characters or the direction of the character(s) in a manner as discussed in the above vision assessments with a specified character contrast ratio. Threshold character size (corrected for user viewing distance) and contrast ratio can be established for a pass/not pass assessment. Scoring of the results may also be similar to the above acuity assessments.

### EXAMPLE 13

### The System Used as Measurement Device

Using any of the acuity determination methods discussed above, the system can display a size of character (adjusted for user viewing distance) that corresponds to the user's best visual acuity. Using this character size as a starting point, the system reduces the contrast ratio of the characters to the background in a manner as discussed above. When the user incorrectly identifies a specified number of character (s) or the direction of a character at a given contrast ratio, the system increases the size of the displayed character to correspond to a new level of acuity at this contrast ratio. This process is repeated to the conclusion of the test based on the number acuity levels and contrast ratios displayed by the system.

Analysis. By following the above procedure, a chart of acuity and contrast ratios can be determined. It is expected that lower contrast ratios will normally be seen only with increasing letter size, corresponding to lower levels of visual acuity at a given distance. Plotting these results and comparing to an age-corrected normal population may allow the system to identify users with below average acuity at lower levels of contrast. These can be indicative of a number of ocular health issues such as, but not limited to, Wagner's hereditary vitro-retinal degeneration, macular edema, diabetic retinopathy, cataract formation, and the result of various ocular surgeries and procedures. The results can also be plotted over time to track various ocular health issues such as those mentioned above.

### EXAMPLE 14

### Amplitude of Accommodation

A user's amplitude of accommodation can be assessed by having them move toward a visual target, such as a chart or computer monitor screen. By measuring their distance, through such means as discussed above, it is possible to determine when a user experiences the “first sign of blur” as they progressively get closer to the visual target. The sign of first blur can be indicated by the user with a keystroke, mouse, joystick, voice, or other input device. This distance can be used to arrive at a user's accommodative ability and age adjusted to determine normal/abnormal accommodative behavior.

### EXAMPLE 15

### Accommodative Facility

The time it takes a user to change his or her focus from a near image to a far image and clearly see the far image can be defined as their ‘near-to-far’ accommodative facility. As a user stresses his or her accommodative system by excessive near work, such as computer work, his or her accommodative facility will reflect an increase in the time required to refocus on distant objects. This same accommodative stress will increase the time it takes to change focus from a distance object to a near object and clearly see the near image, their ‘far-to-near’ accommodative facility.

The accommodative facility can be assessed by having a user view an image at a near distance, such as displayed on the LCD used for near vision assessment for a specified length of time. User is then asked to indicate when he or she is changing his or her focus by means of any of the input devices above, and is asked to focus on a distant image, such as displayed on the LCD used for distant vision assessment. The user again indicates through an input device as soon as this distant image becomes clearly seen. This is her near-to distant accommodative facility. The process can be repeated going from the distant image to the near image repeated a number of times to obtain averages.

### EXAMPLE 16

### Blink Rate

Blink rate may be a significant factor in assessing the condition of dry eye for those engaged for an extended period of time in near point work and working on the computer. The blink rate for these individuals often dramatically decreases causing the corneal surface to dry due to evaporation from exposure to the surrounding atmosphere. The condition of dry eye is often associated with eye redness, a burning sensation, a feeling of foreign body or grittiness in the eye, and blurred vision. Therefore blink rate may be used as a tool to assess the presence and severity of dry eye or the risk of developing dry eye.

Method. A system to calculate the blink rate and determine the interval between blinks known as the Inter Blink Interval (IBI). This can be accomplished by recording the number of times a user blinks in a given period of time and averaging the time interval between blinks over this period. The longest IBI may also be meaningful by giving an indication of periods of possible dryness and the potential risk of developing a dry eye condition.

A second parameter, the Tear Film Break-Up Time (TFBUT) can be obtained by asking the user to refrain from blinking (stare) until the user reports ocular discomfort. Recording the time from last blink to the feeling of ocular discomfort is a close approximation of TFBUT.

Analysis. The blink rate of a statistical sample of users can be correlated with the symptoms of dry eye and levels of severity of dry eye such as mild, moderate, and severe can be related to various threshold values of blink rates. Another method involves comparing an individual's TFBUT with the individual's IBI. A TFBUT that is shorter than the IBI may indicate a dry eye condition and the magnitude of the difference between the two may be used to indicate the severity of the condition such as mild, moderate, and severe.

Utilizing a camera and a light source (such as IR—Infrared), light reflected on the surface of the cornea can be used as dry eye indicator. This method of dry eye assessment involves looking at the change in the brightness and/or sharpness of a reflected image on the surface of the cornea. Measurement of these parameters and the area they occupy may be used to identify the location of the cornea dryness.

### EXAMPLE 17

### Blink Reflex

Knowing a user's blink rate presents the possibility of creating various means of causing the user to blink and measuring the effectiveness of such intervention. The various means to cause a user to blink may be a stimulus that is perceived through one or more of the five senses, either consciously or subliminally. Examples of such stimuli may include, but not limited to, visual excitement that cause a natural blink reflex, an alert or notification to the user of a low blink rate condition, or other biofeedback response involving sight, sound, feeling, smell, and/or hearing.

Tracking the changes in blink rate associated with a given blink stimulus will allow an assessment of the effectiveness of such stimulus and may lead to altering a particular stimulus to produce a greater blink rate or changing to a new stimulus to produce the desired results.

### EXAMPLE 18

### Allergy and Dry Eye Assessment

The assessment of Ocular Allergies and Dry Eyes can be performed by requiring the user to answer certain relevant questions. The answers to these or a similar questions can be assigned numerical values and a point count established to determine the severity of the ocular condition. Categories of severity can be assigned such as mild, low moderate, high moderate, and severe or other such terminology as to describe the user's condition. A recommendation can be associated with each category such as a recommended product or service, or seeing an eye care professional for an eye examination.

### EXAMPLE 19

### Use of the Present System in a Corporate or Industrial Setting

The present system can be set up as follows:

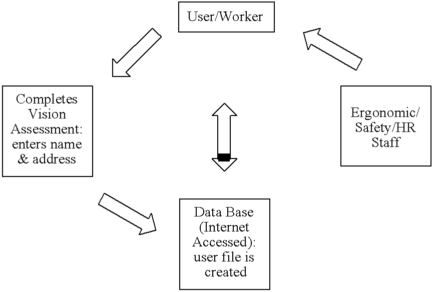

Description. Step 1: A computer worker, factory floor worker, or other company worker completes vision assessment and enters name and email address. Step 2: This information is transmitted to a data base and user file created. Step 3: An ergonomic survey covering topics such as personal history, work patterns, equipment used, environmental conditions, and vision and/or musculosketal symptoms is completed by worker and emailed to data base. An analysis using preprogrammed algorithms is performed from the vision data and the ergonomic survey and emailed to ergonomic/HR/Safety staff and/or user. Periodic vision assessments and ergonomic survey provide ongoing optimization of worker's health, comfort, and performance.

### EXAMPLE 20

### Taking Distance Vision, Near Vision, or Other Vision Assessment to Accommodate Users of Varying Heights

To allow a user, facing the system, to perform a distance vision, near vision, or other vision assessment requires the user to view an image that may be directly displayed, such as on an LCD, or displayed through the use of one or more mirrors. Such a system is provided to accommodate users of varying heights.

Thus the present kiosk provides, in one embodiment, a beam from a distance sensor (such as an InfraRed distance sensor) projected onto an adjustable mirror that is positioned in front of the user. As the adjustable mirror moves to a more vertical position, the InfraRed Beam begins a downward sweep motion. When a signal is produced indicating an object, such as a user, the location of the adjustable mirror is recorded through the feedback loop of the servo mechanism that drives the motion of the mirror. This first signal detection, expressed as an angle, approximates the top of a user's head if the object standing in front of the system is a person. Knowing the distance to the user and the approximate location of the top of the head allows the adjustable mirror to be further moved in a downward direction by a determined amount to position the mirror so the user can see (1) a Display or other viewing target that is situated above the adjustable mirror, or (2) a second mirror located above the adjustable mirror and along an ensuing optical path that may be comprised of additional mirrors and a displayed image at the end of the optical path.

The above InfraRed distance sensor and adjustable mirror/servo mechanism can be employed to determine the height and location of the eyes of a user. This information can be used to activate another servo mechanism to adjust the viewing angle of an object to be viewed for a vision assessment, such as but not limited to that which is displayed on an LCD.

In an alternative embodiment, cameras and software can be used to determine the location of the user's eyes and make the above viewing angle adjustments for varying heights accordingly.

In a further embodiment of the present invention, the user can input his or her approximate height, and the system mechanically adjusts the viewing angle of a display or mirror so the user can see a displayed image for vision assessment.

In still another embodiment, the user sets the angle of the display either manually or mechanically/electrically through buttons or knobs so the user can see a displayed image for vision assessment.

### EXAMPLE 21

### Optical Path

The Optical Path can incorporate more mirrors and shorter distances between mirrors, or fewer mirrors and longer distances between mirrors to accomplish an optical path of a specified distance between user and the displayed object to be viewed by the user depending on the constraints of the size of the system desired. Generally, fewer mirrors provide less degradation of the displayed image but require a longer optical path between individual mirrors to obtain a specified viewing distance between user and the viewed target. More mirrors will increase the degradation of the displayed image but will allow for a shorter optical path between individual mirrors and thus may reduce the size and dimensions of the overall Optical Path. An Optical Path can also be constructed to use mirrors more than once in reflecting an image to create an optical path from the user to the displayed viewing target.

The system of the present invention can be applied to various products, including but not limited to:
(1) A Self-Assessment Kiosk Vision Center (“VisionCheck”)—providing vision assessment to consumers in public venues that can be a stand alone, wall mounted, or desk top unit. The functionality of this unit includes screening, thus the visual acuity threshold assessed is typically greater than 20/20 vision)
(2) A Self-Assessment Kiosk Vision Center (“VisionPro”)—providing vision assessment in a professional eye care or medical environment that can be a stand alone, wall mounted, or desk top unit. The functionality of this unit may be the same as VisionCheck or include additional assessments more suitable for the professional market. Also, rather than a screening device, the system thresholds would be more in alignment with professional standards of 20/20 or better visual acuity assessments.
(3) A Self-Assessment Vision Center With Additional Software That Provides Assessment, Recommendations And Solutions For Increasing Productivity, Health, And Comfort Of Computer Users. (“VisionCentral” FIGS. 21-37)—can be a stand alone, wall mounted, or desk top unit. Analysis may occur within the unit or the unit may be Internet connected to a central database where data is received, analyzed, and provided to user and/or other parties such as eye care professionals, and ergonomic staff. This product can be marketed to the eye care professional or placed in corporations to assess and provides solutions to computer vision syndrome problems of the computer workforce. This product consists of a moveable monitor display that allows a user to adjust the distance between the monitor and their eyes.

1-85. (canceled)

86. A system comprising a kiosk that comprises: (a) an optical chamber; (b) at least one display screen; (c) an input device; (d) one or more sensors; (e) a means for adjusting an optimal viewing angle between the user and the device; (f) a microprocessor for processing input and output; and (g) a memory for storage of input or output, wherein the system is configured to accept input from one or more of the input devices, the sensor and the servo mechanism, and to provide output to one or more of the optical chamber and the screen.

87. The system of 86 wherein the means for adjusting the optimal viewing angle comprises a servo mechanism.

88. The system of 86, wherein the means for adjusting the optimal viewing angle comprises a manual means such as a knob or an adjustable display screen.

89. The system of 86, wherein the kiosk further comprises a means for determining a user's location relative to the one or more display screens.

90. The system of 89, wherein the means for determining user's location is a distance sensor or an image sensor.

91. The system of 86, wherein the kiosk further comprises a means for determining a user's height or location of a user's eyes.

92. The system of 86, wherein the kiosk further comprises a means for automatically adjusting vision assessment to a user's height.

93. The system of 92, wherein the means for automatically adjusting the vision assessment is a servo mechanism, including both hardware and software.

94. The system of 86, wherein the kiosk further comprises a means for automatically adjusting size of displayed characters to a specified accuracy (such as 20/20 or 20/40) based on a user's location or position.

95. The system of 94, wherein the means for automatically adjusting size of displayed characters comprises a software program.

96. The system of 86, wherein the kiosk further comprises a means for providing a variable intermediate or distance vision assessment.

97. The system of 96, wherein the means for providing a variable intermediate or distance vision assessment comprises a combination of mechanical and software means.

98. The system of 97, wherein the mechanical means comprises mechanically moving the display screen.

99. The system of 97, wherein the software is configured to display a plurality of “C's” of size corresponding to a particular vision measurement, and assessments, after determining the distance between the display and wherein a user positioned in front of the display.

100. The system of 86, wherein the kiosk further comprises a means for retrieving or analyzing information.

101. The system of 86, further comprising a printer.

102. The system of 86, wherein the input device comprises physical or voice recognition.

103. The system of 86, wherein the system is configured to assess a user's vision or ocular health.

104. The system of 103, wherein the assessment is based on a user's input.

105. The system of 86, wherein the system is configured to provide information about vision problems or eye health issues.

106. The system of 86, wherein the system is configured to provide one or more suggestions regarding one or more products or services, such as vision related products or services.

107. The system of 86, wherein the system is adapted to provide one or more coupons for one or more vision related products or services.

108. The system of 103, wherein the assessment of a user's vision or ocular health is selected from the group consisting of assessment of distant vision, assessment of near vision, assessment of intermediate vision, assessment of computer vision, assessment of central vision, assessment of field of clear view, assessment of accommodation, assessment of accommodative facility, assessment of contrast acuity, assessment of ocular allergies, assessment of dryness of eyes (mild, moderate, sever), assessment of blink rate (in number of blinks per minute), assessment of tear film breakup and assessments of combinations thereof.

109. The system of 103, wherein the system is configured to provide a recommendation based upon the assessment.

110. The system of 109, wherein the recommendation relates to potential remedies or referral to an eye specialist or to a product or to a service.

111. The system of 86, wherein the system is designed to allow a user to stand or sit in front of the screen.

112. The system of 111, wherein the system is a stand-alone unit or a wall-mounted system or a desk top unit.

113. The system of 111, wherein the system is incorporated into a retail shelving system.

114. The system of 113, wherein the retail shelving system displays vision care products.

115. The system of 86, wherein the at least one display screen is a touch screen or LCD.

116. The system of 86, wherein the system comprises two or more display screens.

117. The system of 86, wherein the display screen is configured to display one or more of: a menu, a means for navigation, results of assessment, recommended products or services, and operating instructions, for example, as displayed on a Main Display.

118. The system of 86, wherein the system or display screen is configured to display vision assessment information at near vision, distance vision, and intermediate vision scale.

119. The system of 86, wherein system is configured to display assessment information through a mirror assembly.

120. The system of 119, wherein the mirror assembly is so placed such that a path of sight varies from several inches to one or more meters.

121. The system of 119, wherein the mirror assembly is automatically adjustable to account for users of varying heights.

122. The system of 119, wherein the mirror assembly is manually adjustable.

123. The system of 86, wherein the at least 1 display screen is movable.

124. The system of 123, wherein the display screen is movable to create a desired path length related to a specific visual acuity relative to position of a user.

125. The system of 123, wherein the display screen is movable to create a target letter size relative to position of a user.

126. The system of 86, wherein the system is configured to automatically adjust a letter size for display.

127. The system of 126, wherein the system is configured to adjust the letter size to maintain a correct acuity assessment for a user upon user's movement, if any, during assessment.

128. The system of 86, wherein the display screen is manually adjustable to accommodate a user's height or distance from the screen.

129. The system of 86, wherein the display screen is automatically adjustable.

130. The system of 86, wherein the system comprises a means to detect a user position.

131. The system of 86, wherein the system comprises a means to detect a user's distance from the one or more displays.

132. The system of 86, wherein the at least one sensor comprises a distance sensor.

133. The system of 132, wherein the distance sensor is an infrared, optical (camera) or an acoustic sensor.

134. The system of 86, wherein at least one sensor is a camera.

135. The system of 86, further comprising an infrared source.

136. The system of 86, further comprising one or more means to identify the eye region of a user, determine blink rate (blinks per minute), determine completeness of blink, determine vertical size of eye aperture (opening of the eye), and pupil size.

137. The system of 86, wherein the system is configured to record response time for a user to respond to a query.

138. The system of 86, wherein the system is configured to record a level of blur.

139. The system of 86, wherein the system comprises an eye-tracking means.

140. The system of 86, further comprising at least one speaker for sound projection.

141. The system of 140, wherein the sound level of the kiosk, particularly the advertisements thereon, can be automatically turned on or off or adjusted when an approaching person is sensed.

142. The system of 141, wherein audio is minimal until a person is sensed and is increased in volume as the person comes in close proximity to the kiosk. This prevents needless sound that may be annoying to persons in retail or other settings where the kiosk may be placed.

143. The system of 86, wherein the at least one sensor comprises a light sensor.

144. The system of 143, wherein the light sensor detects intensity of ambient light.

145. The system of 143, wherein the light sensor detects light directed to surface of the display.

146. The system of 86, wherein the at least one sensor comprises a humidity sensor.

147. The system of 86, wherein the system is operationally Internet enabled to download and upload information such as, but not limited to, the import of new software, advertising, coupons, and educational material, and to retrieve user information, kiosk use statistics, maintenance, and operating status.

148. The system of 86, wherein the system is configured to send email.

149. The system of 86, wherein the system is configured to accept information regarding the user.

150. The system of 86, wherein the system is configured to issue one or more coupons.

151. The system of 150, wherein the coupon is for a recommended product.

152. The system of 86, further comprising a means to dispense a sample.

153. The system of 86, further comprising an ear or head phone.

154. The system of 86, further comprising a means to assess a user's hearing.

155. The system of 86, wherein the system is configured to assess a user's personal care needs.

156. The system of 155, wherein the system is configured to assess a user's over-the-counter medical or health care needs.

157. The system of 86, wherein the system is configured to provide name and/or location of a service provider or a retailer or manufacturer.

158. A method of advertising to a user comprising the steps of:
a. providing a kiosk in a private, semi-private or public location;
b. accepting input from a user regarding user's personal product or service need; and
c. providing information regarding recommended product or service.

159. The method of 158, wherein the product or service need is vision-related.

160. A method of assessing a user's personal, medical or health care needs comprising:
d. providing the system of 86;
e. allowing the system to display information or one or more questions relating to the user's personal, medical or health care needs;
f. allowing the system to accept the user's response to one or more questions or user's input into the system;
g. allowing the system to analyze user's response; and
h. allowing the system to provide user with one or more result of analysis.

161. The method of 160, further comprising the step of allowing the system to provide a suggestion or recommendation for a product or service.
